(19) United States
(12) Patent Application Publication
(10) Pub. No.: US 2001/0028486 A1
(43) Pub. Date: Oct. 11, 2001

(54) Token access system

(75) Inventor: Masayuki Kashima, Tokyo (JP)

Correspondence Address: VENABLE, P.O. Box 34385, Washington, DC, 20043-9998, US

(73) Assignee: Oki Electric Industry Co., Ltd.

(21) Appl. No.: 09/773,007

(22) Filed: Jan. 31, 2001

(30) Foreign Application Priority Data
Apr. 5, 2000 (JP) 103667/2000

(51) Int. Cl. H04B 10/20; H04J 14/00; H04B 10/00

(52) U.S. Cl. 359/118; 359/154

(57) ABSTRACT

A network system has a dedicated channel for circulating tokens, and also has data transmission channels. The data transmission channels are different for each node. By using tokens, connections are established between nodes. Data can be sent and received between nodes which have established a connection irrespective of the acquisition of a token. Thus data exchange efficiency is improved.

### BACKGROUND OF THE INVENTION

1. Field of the Invention

This invention relates to a network system that employs the token access method.

2. Description of Related Art

Network systems that perform optical communications using the token access method are known in the prior art. The token access method is described, for example, in the reference “Denshi Joho Tsushin Handobukku (Handbook for Electronics, Information and Communication Engineers),” edited by The Institute of Electronics, Information and Communication Engineers, published by Ohm, 1988, pp 2660-2661. With the token access method, a plurality of nodes is connected in a ring, and special data called tokens are circulated between the nodes. A terminal is connected to each node. Each node is able to transmit data input from a terminal toward another node, using light as a medium, only when a token has been acquired.

As described above, however, each terminal cannot transmit data unless the node connected to that terminal has received a token. Accordingly, in a conventional network system, data transfer efficiency is low.

### SUMMARY OF THE INVENTION

That being so, an object of the present invention is to improve data transfer efficiency in a network system over what it is conventionally.

In order to attain that object, the network system of the present invention exhibits the unique configuration described below.

The network system of the present invention comprises n terminals and n nodes (where n is an integer 2 or greater). In the present invention, each terminal is connected to each node individually. Also, the nodes are connected to each other to form a communications network. In this communications network are established a connection establishing channel, and data transmission channels assigned to each node.

Each of the nodes uses the connection establishing channel to continually circulate a token in the communications network. Provision is made so that a node, when it has acquired a token, can make a request to establish a connection between another node using the connection establishing channel. After the connection is established, that node uses a data transmission channel to transmit data.

Thus, with this network system, channels are provided separately for circulating tokens and for transmitting data, and the data transmission channel is made different for each node. Accordingly, data can be sent and received between nodes that have established a connection irrespective of token acquisition. Data transfer efficiency is therefore enhanced in the network system.

In implementing the present invention, it is preferable that the communications network be made an optical communications network such that connections are established electrically between the terminals and the nodes, and such that the mutual connections between the nodes are effected optically. When that is the case, the nodes may be such as to perform conversions from optical signals to electrical signals or conversions from electrical signals to optical signals.

If the configuration is made in this way, data transfers between nodes are performed by optical signals, wherefore communications can be made high speed.

In implementing the present invention, furthermore, it is preferable that the nodes be such that, when a data transmission request has been issued to the terminal connected to a particular node, when acquiring a token, that node transmits connection information necessary for establishing a connection to the node to which the data are to be transmitted.

Information such as the address of the data transmitting entity is included in the connection information. The node to which data are being transmitted, upon receiving the connection information, if data reception is possible, matches the reception channel to a prescribed channel corresponding to the address informed of by the connection information, thereby establishing a data transfer connection between the nodes.

In implementing the present invention, it is even more preferable that provision be made so that connection information is bundled together with a token and transmitted as a token packet.

In implementing the present invention, furthermore, the configuration may ideally be made as follows.

That is, the data transmission channels are to be made n channels that are assigned beforehand, one channel to each node, with no redundancy. Also, the connection establishing channel is to be made the (n+1)th channel. A node comprises a transmitter, a receiver, and a connection processor. The transmitter comprises first and second data transmitters and first and second token transmitters. The receiver comprises first and second data receivers and first and second token receivers.

The connection processor is connected to the terminal, the first token transmitter, and the second token receiver. The first data transmission unit and the second data receiver are connected, respectively, to the terminal. The first data receiver and the second data receiver are connected. The first token receiver is connected to the second token receiver. The second data transmitter is connected to the first data transmitter. And the second token transmitter is connected to the first token transmitter.

The first data transmitter converts data received from the terminal to first data in a prescribed format, and transmits those first data to the second data transmitter. The second data transmitter converts the first data received from the first data transmitter to second data for one of the data transmission channels, and transmits those second data to the communications network. The first token transmitter produces a token packet and transmits that token packet to the second token transmitter. The second token transmitter converts the token packet received from the first token transmitter to a first token packet for the (n+1)th channel, and transmits that first token packet to the communications network.

The first data receiver selects one of the data transmission channels, thereby receiving the second data from the communications network, then converts those second data to first data, and transmits those first data to the second data receiver. The second data receiver converts the first data received from the first data receiver to data, and transmits those data to the terminal. The first token receiver receives the first token packet from the communications network using the (n+1)th channel, converts that first token packet to a token packet, and transmits that token packet to the second token receiver. From the token packet received from the first token receiver, the second token receiver extracts the token and the connection information relating to that second token receiver, and transmits that token and connection information to the connection processor.

The connection processor, upon receiving a data transmission request from a terminal connected to that connection processor, performs processing to cause the first token transmitter to produce prescribed connection information. Also, that connection processor, upon receiving a token and connection information from the second token receiver, when it is possible to establish a connection, performs processing to cause the first data receiver connected to that connection processor to select the data transmission channel assigned to the node from which the transmission was made.

Based on this configuration, the connection processor matches the data reception channel to the channel assigned to the node from which data have been sent, based on the connection information received. As a consequence, data reception is made possible.

In implementing the present invention, furthermore, it even more preferable that the communications network be an optical communications network such that the connections between terminals and nodes are made electrically and such that mutual connections between the nodes are effected optically. When that is the case, the data, the first data and the token packets are electrical signals and the second data and the first token packet are optical signals.

If the configuration is made in that way, data transfer between nodes will be performed by optical signals, wherefore communications will be made high-speed.

In implementing the present invention, furthermore, it is preferable to make the configuration as described below.

Specifically, first let it be assumed that the data transmission channels have light wavelengths from λ₁ to λₙ, and that the (n+1)th channel has a light wavelength of λₙ₊₁. The second data transmitter is a first electric-to-optical conversion device for converting the received first data to second data having one of wavelengths from λ₁ to λₙ. The first data receiver comprises a variable wavelength filter and a first optical-to-electric conversion device. The variable wavelength filter receives second data from the communications network by selecting one of wavelengths from λ₁ to λₙ. The first optical-to-electric conversion device converts the second data sent from the variable wavelength filter to first data.

The second token transmitter is a second electric-to-optical conversion device for converting received token packets to first token packets having a wavelength of λₙ₊₁. And the first token receiver comprises a fixed wavelength filter and a second optical-to-electric conversion device. This fixed wavelength filter receives first token packets having a wavelength of λₙ₊₁ from the communications network. The second optical-to-electric conversion device converts first token packets sent from the fixed wavelength filter to token packets.

Based on this configuration, a wavelength division multiplexing type of network system is implemented.

In implementing the present invention, furthermore, it will be well to make the configuration as described below.

Specifically, first let it be assumed that the data transmission channels are respectively designated by the codes C₁ to Cₙ in code division multiple access. Also, let it be assumed that the (n+1)th channel is designated by the code Cₙ₊₁ in code division multiple access. The second data transmitter comprises a first CDMA spreading device and a first electric-to-optical conversion device. The first CDMA spreading device spreads the first data received with one of the codes from C₁ to Cₙ, converting those data to third data. The first electric-to-optical conversion device converts the third data sent from the first CDMA spreading device to second data.

The first data receiver comprises a first optical-to-electric conversion device and a first CDMA reverse spreading device. The first optical-to-electric conversion device converts second data received to third data. The first CDMA reverse spreading device subjects third data sent from the first optical-to-electric conversion device to reverse spreading with any one of the codes from C₁ to Cₙ, converting those data to first data.

The second token transmitter comprises a second CDMA spreading device and a second electric-to-optical conversion device. The second CDMA spreading device spreads the token packets received with the code Cₙ₊₁, converting them to second token packets. The second electric-to-optical conversion device converts second token packets sent from the second CDMA spreading device to first token packets.

The first token receiver comprises a second optical-to-electric conversion device and a second CDMA reverse spreading device. The second optical-to-electric conversion device converts first token packets received to second token packets. The second CDMA reverse spreading device subjects second token packets sent from the second optical-to-electric conversion device to reverse spreading with the code Cₙ₊₁, converting those to token packets.

Based on this configuration, a code division multiple access network system is realized.

In implementing the present invention, it is preferable that the third data transmitted from the first CDMA spreading device and the second token packets transmitted from the second CDMA spreading device are led through an electrical converging device to one transmission path. Also, it preferable that this transmission path is connected to an electric-to-optical conversion device that functions both as the first electric-to-optical conversion device and as the second electric-to-optical conversion device.

Based on this configuration, the number of components is reduced, wherefore the nodes can be made smaller.

In implementing the present invention, it is preferable that provision be made so that the second data and first token packets sent from the communications network be input to a optical-to-electric conversion device that functions both as the first optical-to-electric conversion device and as the second optical-to-electric conversion device. Also, it is preferable that one transmission path connected to that optical-to-electric conversion device be coupled to the first and second CDMA reverse spreading devices via an electrical branching device.

Based on this configuration, the number of components is reduced, wherefore the nodes can be made smaller.

In implementing the present invention, furthermore, it is preferable that each of the first and second electric-to-optical conversion devices comprises a light source for outputting light and an intensity modulating device. The intensity modulating device modulates the intensity of light output from the light source according to received second token packets or third data, and transmits that modulated light as a first token packet or second data.

In implementing the present invention, moreover, it is suitable to make the configuration as follows.

Specifically, let it first be assumed that n=n(p,q)=p×q (where p and q are natural numbers). Let it be further assumed that the data transmission channel is designated by a combination of the light wavelength λᵢ (where i is a natural number from 1 to p) and the code Cⱼ (where j is a natural number from 1 to q) in code division multiple access. Let it also be assumed that the (n+1)th channel has a light wavelength of λₚ₊₁.

The second data transmitter comprises a CDMA spreading device and a first electric-to-optical conversion device. The CDMA spreading device spreads first data received with one of the codes from C₁ to C_{q}, converting those data to third data. The first electric-to-optical conversion device converts the third data sent from the CDMA spreading device to second data having one of the wavelengths from λ₁ to λₚ.

The first data receiver comprises a variable wavelength filter, a first optical-to-electric conversion device, and a CDMA reverse spreading device. The variable wavelength filter selects one of the wavelengths from λ₁ to λₚ and thereby receives second data from the communications network. The first optical-to-electric conversion device converts the second data sent from the variable wavelength filter to third data. The CDMA reverse spreading device subjects the third data sent from the first optical-to-electric conversion device to reverse spreading with one of the codes from C₁ to C_{q}, converting those data to first data.

The second token transmitter is a second electric-to-optical conversion device that converts token packets received to first token packets having a wavelength of λₚ₊₁.

The first token receiver comprises a fixed wavelength filter and a second optical-to-electric conversion device. The fixed wavelength filter receives first token packets of wavelength λₚ₊₁ from the communications network. The second optical-to-electric conversion device converts the first token packets sent from the fixed wavelength filter to token packets.

Based on this configuration, a multiplexing network system is realized that combines wavelength division multiplexing with code division multiple access.

In implementing the present invention, it is preferable that the first electric-to-optical conversion device comprise a light source for outputting light, a filter, and an intensity modulating device. The filter passes only that light output from the light source which has one of the wavelengths from λ₁ to λₚ. The intensity modulation device modulates the intensity of the light output from the filter according to the third data received and transmits that modulated light as second data.

In implementing the present invention, it is preferable that the second electric-to-optical conversion device comprise a light source for outputting light, a filter, and an intensity modulation device. The filter passes only that light output from the light source having a wavelength of λₚ₊₁. The intensity modulation device modulates the intensity of the light output from the filter according to token packets received, and transmits that modulated light as a first token packet.

Another network system of the present invention has the unique configuration described below. That is, this network system comprises n terminals and n nodes (where n is an integer 2 or greater). In the present invention, moreover, the individual terminals are connected electrically to the individual nodes. The individual nodes are mutually connected optically to configure an optical communications network.

In the present invention, furthermore, the nodes comprise transmitters and receivers. These transmitters and receivers are connected respectively to terminals.

The transmitter noted above comprises a CDMA spreading device and a electric-to-optical conversion device. The CDMA spreading device spreads data received from a terminal with a prescribed code and converts those data to first data. The electric-to-optical conversion device converts the first data sent from the CDMA spreading device to second data that are optical signals, and transmits those second data to an optical communications network.

The receiver noted above comprises an optical-to-electric conversion device and a CDMA reverse spreading device. The optical-to-electric conversion device converts second data received from the optical communications network to first data that are electric signals. The CDMA reverse spreading device subjects the first data sent from the optical-to-electric conversion device to reverse spreading with a prescribed code, to convert those first data to data and transmits those data to a terminal.

Based on this configuration, data reproducibility is good because code division multiple access is conducted. Also, data transfers between nodes are conducted by optical signals, wherefore communications can be made high-speed.

In implementing this network system, it is preferable that the electric-to-optical conversion device comprise a light source for outputting light and an intensity modulation device. The intensity modulation device modulates the intensity of the light output from the light source according to first data received and transmits that modulated light as second data.

### BRIEF DESCRIPTION OF THE DRAWINGS

The forgoing and other objects, features and advantages of the present invention will be better understood from the following description taken in connection with the accompanying drawings, in which:

FIG. 1 is a block diagram of the configuration of a network system in a first embodiment;

FIG. 2 is a block diagram for describing operations of the network system when transferring data;

FIG. 3 (inclusive of FIGS. 3A, 3B, 3C, 3D, and 3E) is a set of diagrams showing how token packets are configured;

FIG. 4 is a block diagram of the internal configuration of a terminal and a node;

FIG. 5 is a block diagram of the configuration of a transmitter;

FIG. 6 is a block diagram of the configuration of a receiver;

FIG. 7 is a flowchart for describing the operations of a network system;

FIG. 8 (inclusive of FIGS. 8A, 8B, and 8C) is a set of flowcharts for connection establishing request procedures;

FIG. 9 is a flowchart for procedures implemented when a second node responds to a request to establish a connection from a first node;

FIG. 10 (inclusive of FIGS. 10A, 10B, and 10C) is a set of flowcharts implemented when the first node selects a data reception channel;

FIG. 11 (inclusive of FIGS. 11A and 11B) is a set of flowcharts that mainly indicate procedures to be implemented when the second node selects a data reception channel;

FIG. 12 (inclusive of FIGS. 12A and 12B) is a set of flowcharts for procedures for data reception between terminals, particularly when data are transmitted from the first terminal to the second terminal;

FIG. 13 (inclusive of FIGS. 13A and 13B) is a set of flowcharts for procedures for data reception between terminals, particularly when data are transmitted from the second terminal to the first terminal;

FIG. 14 (inclusive of FIGS. 14A, 14B, and 14C) is a set of flowcharts for procedures implemented when the second node does not respond to a request to establish a connection from the first node;

FIG. 15 is a block diagram of the configuration of a network system in a second embodiment;

FIG. 16 is a block diagram of the internal configuration of a terminal and a node;

FIG. 17 is a block diagram of the configuration of a transmitter;

FIG. 18 is a block diagram of the configuration of a receiver;

FIG. 19 is a block diagram of the configuration of a network system in a third embodiment;

FIG. 20 is a block diagram of the internal configuration of a terminal and a node;

FIG. 21 is a block diagram of the configuration of a transmitter;

FIG. 22 is a block diagram of the configuration of a receiver;

FIG. 23 is a graph representing the spectrum intensity of light output from a light source;

FIG. 24 is a block diagram of the configuration of a network system in a fourth embodiment;

FIG. 25 is a block diagram of the internal configuration of a terminal and a node;

FIG. 26 is a block diagram of the configuration of a transmitter; and

FIG. 27 is a block diagram of the configuration of a receiver.

### DESCRIPTION OF THE PREFERRED EMBODIMENTS

Embodiments of the present invention are now described with reference to the drawings. The drawings represent connection relationships and the like in a simplified manner sufficient for the present invention to be understood. Thus the present invention is not limited to or by the examples represented in the drawings.

[First Embodiment]

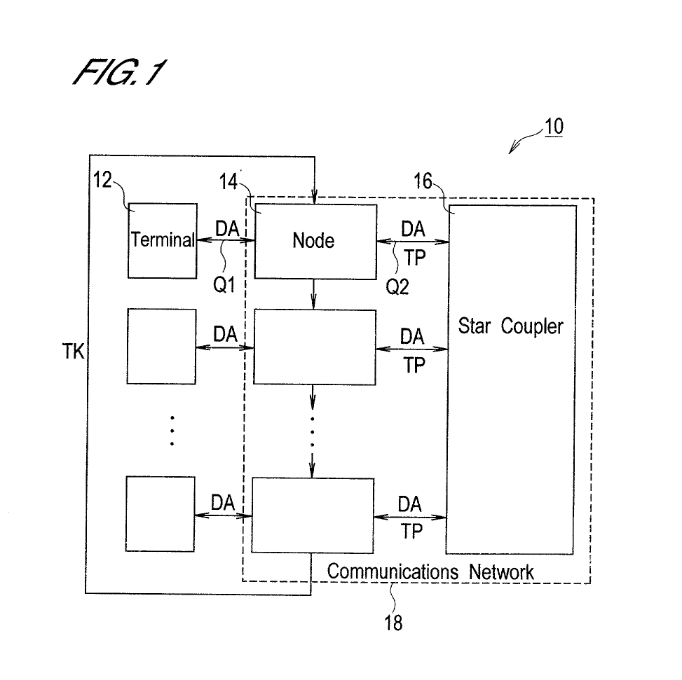

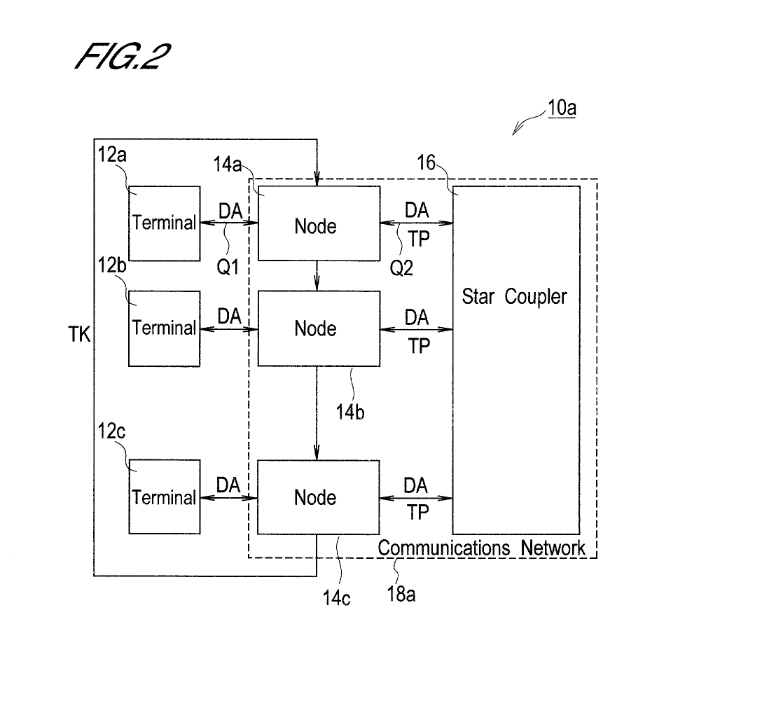

First, the configuration of a network system in a first embodiment is described, with reference to FIG. 1. FIG. 1 is a block diagram of the configuration of the network system in the first embodiment. In FIG. 1, the logical configuration is diagrammed in addition to the actual physical configuration in order to facilitate understanding of the operations of this network system.

This network 10 is configured with n terminals 12 and n nodes 14 (where n is an integer 2 or greater), and with a star coupler 16. Each of the terminals 12 is connected individually to each of the nodes 14. Also, each of the nodes 14 are mutually connected via the star coupler 16 to configure a communications network 18.

Each of the terminals 12 is an electrical device, and the connections between the terminals 12 and the nodes 14 are made electrically. Specifically, the terminals 12 and the nodes 14 are connected by an electrical circuit line Q1. The mutual connections between the nodes 14 are made optically. Specifically, each of the nodes 14 is connected to the star coupler 16 by a light transmission path Q2. A waveguide path or optical fiber is used for the light transmission path Q2. The node 14 has functions for converting from optical signals to electrical signals or for converting from electrical signals to optical signals. More specifically, the node 14, after converting an electrical signal sent from the terminal 12 to an optical signal, outputs that optical signal to the star coupler 16. And after converting an optical signal sent from the star coupler 16 to an electrical signal, the node 14 outputs that electrical signal to the terminal 12.

In the communications network 18 noted above, a connection establishing channel and data transmission channels assigned to each of the nodes 14 are established. Each of the nodes 14 uses the connection establishing channel to continually circulate special data called a token TK in the communications network 18. That is, the nodes 14 send tokens TK in a determined order.

In FIG. 1 is drawn a dedicated circuit for transferring the tokens TK. As noted already, however, this circuit is drawn in order to facilitate understanding the operation of the network system 10, and does not physically exist. In actuality, the tokens TK are transferred sequentially to the nodes 14 via the nodes 14, the light transmission path Q2, and the star coupler 16.

In this network system 10, the node 14 is made so that it can request the establishing of a connection with another node 14 when a token TK is acquired, using the connection establishing channel. After the connection is established, the node 14 uses a data transmission channel to transmit data DA. Accordingly, data transmissions can be conducted between nodes with which a connection has been established irrespective of token TK acquisition. Hence data transfer efficiency in this network system 10 is enhanced over the prior art.

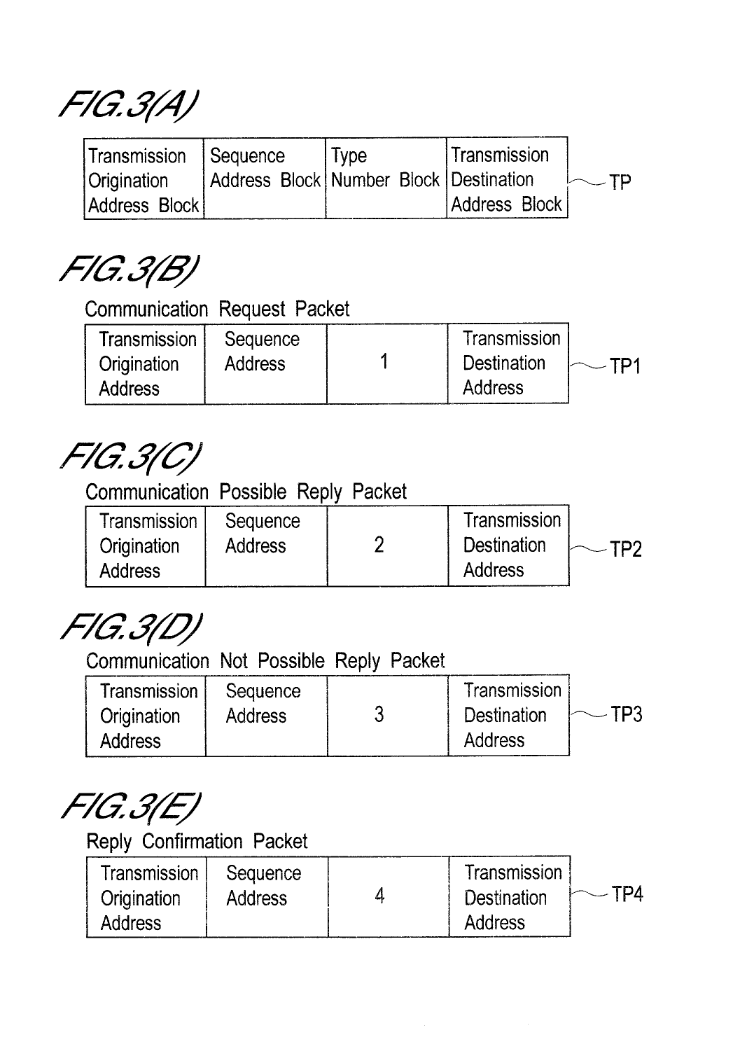

Next, as diagrammed in FIG. 2, taking as an example the case of a network system 10a where n=3, the operations of this network system 10a when transferring data are described. This network system 10a comprises three nodes, 14a, 14b, and 14c. These nodes 14a, 14b, and 14c are mutually connected by the star coupler 16 to configure a communications network 18a. To the nodes 14a, 14b, and 14c are connected terminals 12a, 12b, and 12c, respectively.

In this network system 10a, a token TK is circulated around the nodes 14a, 14b, and 14c, in that order, via the virtual circuit diagrammed in FIG. 2. In other words, the token TK sent out from the first node 14a is transferred to the second node 14b. Next, the second node 14b, upon receiving the token TK from the first node 14a, sends the token TK to the third node 14c. Next, the third node 14c, upon receiving the token TK from the second node 14b, sends the token TK to the first node 14a.

We now consider the case where data DA are transmitted from the first terminal 12a to the second terminal 12b.

First, the first terminal 12a sends a data transmission request to the first node 14a. The first node 14a which receives the data transmission request, upon acquiring the token TK sent from the third node 14c, obtains access rights to the communications network 18a.

Next, the first node 14a, having obtained the access rights, sends a connection establishing request to the second node 14b. More specifically, the first node 14a, using a channel that is for circulating tokens TK, transmits the connection information necessary to establishing the connection to the second node 14b. The first node 14a sends out the token TK and passes the access rights to the second node 14b.

Following thereupon, the second node 14b, having received the connection establishing request, accepts the token TK from the first node 14a, and so obtains the access rights to the communications network 18a. The second node 14b, having obtained the access rights, uses the connection establishing channel to send information as to whether or not it is possible to receive the data DA (which information is hereinafter called the connection information) to the first node 14a. Then the second node 14b sends out the token TK, and passes the access rights to the third node 14c.

The connection information sent out from the second node 14b, after passing through the third node 14c, is received by the first node 14a. When data DA reception is possible at the second node 14b, processing is performed to establish a connection between the first node 14a and the second node 14b.

Specifically, the second node 14b matches the data reception channel with the data transmission channel assigned to the first node 14a. Thereby a communication path for transferring data DA from the first node 14a to the second node 14b is secured between the first node 14a and the second node 14b. Provision is also made so that data DA can be transmitted from the second node 14b to the first node 14a. Thus the first node 14a matches the data reception channel to the data transmission channel assigned to the second node 14b, thereby securing a communication path between the first node 14a and the second node 14b for transferring data DA from the second node 14b to the first node 14a.

A connection is thus established between the first node 14a and the second node 14b by the procedures described above. After this connection is established, data DA are transmitted from the first terminal 12a. The data DA transmitted from the first terminal 12a, after passing through the first node 14a and the second node 14b, are received by the second terminal 12b. Also, because the data transmission channel and the connection establishing channel are separate, the token TK circulates within the communications network 18a even when data are being transferred. In other words, data transfers can be conducted between the first node 14a and the second node 14b irrespective of the acquisition of a token TK.

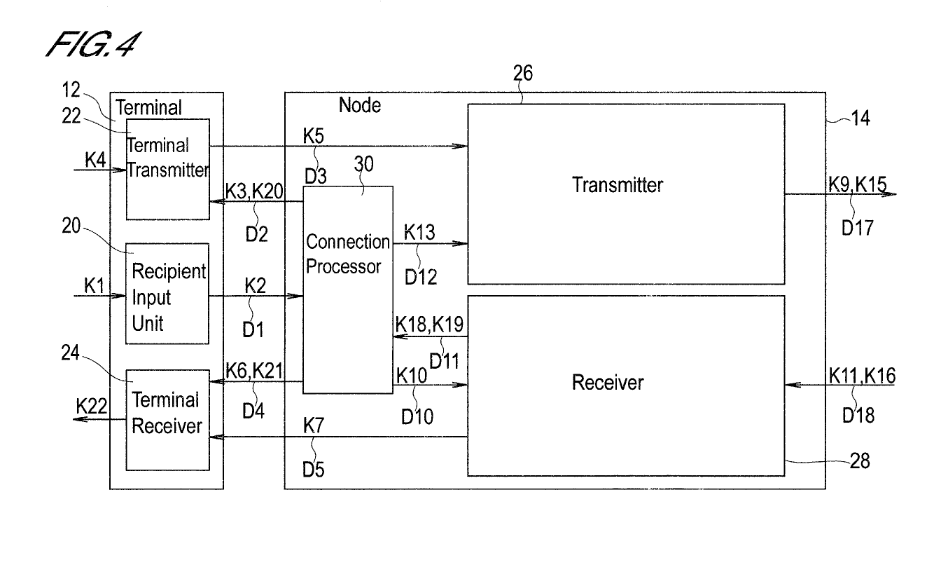

In the network system in this embodiment, furthermore, provision is made so that the nodes transmit the connection information described above together with a token TK as a token packet TP. The configuration of this token packet TP is diagrammed in FIG. 3.

As diagrammed in FIG. 3A, the token packet TP is configured of four basic blocks. The first block is a transmission origination address block. The address of the terminal 12 that is the transmission originator of the connection information (hereinafter called the transmission origination address) is stored in this first block. The second block is a sequence address block. The address of the terminal 12 that is the transmission destination of the token packet TP (hereinafter called the sequence address) is stored in this second block. This sequence address is information corresponding to the token TK.

The third block in the token packet TP is a type number block. A type number for identifying the type of the token packet TP is stored in this third block. The fourth block is the transmission destination address block. The address of the terminal 12 that is the transmission destination of the connection information (hereinafter called the transmission destination address) is stored in this fourth block. The type number and the transmission destination address are information that corresponds with the connection information described earlier. The third and fourth blocks are empty in the initial condition.

The transmission origination address, the sequence address, and the transmission destination address are entities that represent addresses of the terminals 12 described in the foregoing, but they are also entities that represent addresses of the nodes 14 connected to the terminals 12.

Next, as one example, a case is considered where, in the network system 10a diagrammed in FIG. 2, connection information is sent from the first node 14a to the third node 14c. In this case, the first node 14a, when transmitting a token packet TP, writes the address of that first node 14a into the first block. The first node 14a also writes the address of the second node 14b into the second block. The first node 14a also writes the prescribed type number into the third block. And the first node 14a also writes the address of the third node 14c into the fourth block.

Then, the token packet TP sent from the first node 14a is transferred to the second node 14b designated by the sequence address. The second node 14b verifies that the address written to the fourth block in the token packet TP received is not the address of that second node 14b. Then the second node 14b transmits the token packet TP to the third node 14c. In the first block in that token packet TP is written the address of the first node 14a. In the second block of that token packet TP is written the address of the third node 14c. In the third block of that token packet TP is written the same number as the type number written by the first node 14a. And in the fourth block of that token packet TP is written the address of the third node 14c.

Next, the token packet TP sent from the second node 14b is transferred to the third node 14c designated by the sequence address. The third node 14c verifies that the address written in the fourth block of the token packet TP received is the address of that third node 14c. Then, the third node 14c verifies the type number written in the third block in the token packet TP received. The third node 14c also verifies the transmission origination address written in the first block of the token packet TP received. Thus the third node 14c verifies that the connection information received was sent from the first node 14a. After that, the third node 14c will perform processing according to the type number noted earlier.

The numbers 1 to 4 are provided as type numbers. As diagrammed in FIG. 3B, a token packet TP1 wherein the type number 1 is written in the third block is a communication request packet. This communication request packet, as was described with reference to FIG. 2, is sent from the first node 14a when, for example, the first node 14a makes a request to the second node 14b to establish a connection. In this case, the first node 14a writes the type number 1 into the third block, and writes the address of the second node 14b into the fourth block.

As diagrammed in FIG. 3C, the token packet TP2 wherein the type number 2 is written to the third block is a communication possible reply packet. This communication possible reply packet is transmitted from the second node 14b when data reception is possible at the second node 14b which has received a communication request packet from the first node 14a, for example. In this case, the second node 14b writes the type number 2 into the third block and writes the address of the first node 14a into the fourth block.

As diagrammed in FIG. 3D, the token packet TP3 wherein the type number 3 is written to the third block is a communication not possible replay packet. This communication not possible reply packet is transmitted from the second node 14b when it is not possible to receive data at the second node 14b which has received a communication request packet from the first note 14a, for example. In that case, the second node 14b writes the type number 3 to the third block and writes the address of the first node 14a into the fourth block.

And as diagrammed in FIG. 3E, the token packet TP4 wherein the type number 4 is written in the third block becomes a reply confirmation packet. This reply confirmation packet is transmitted to the second node 14b by the first node 14a which received the communication possible replay packet from the second node 14b. In that case, the first node 14a writes the type number 4 in the third block and writes the address of the second node 14b into the fourth block.

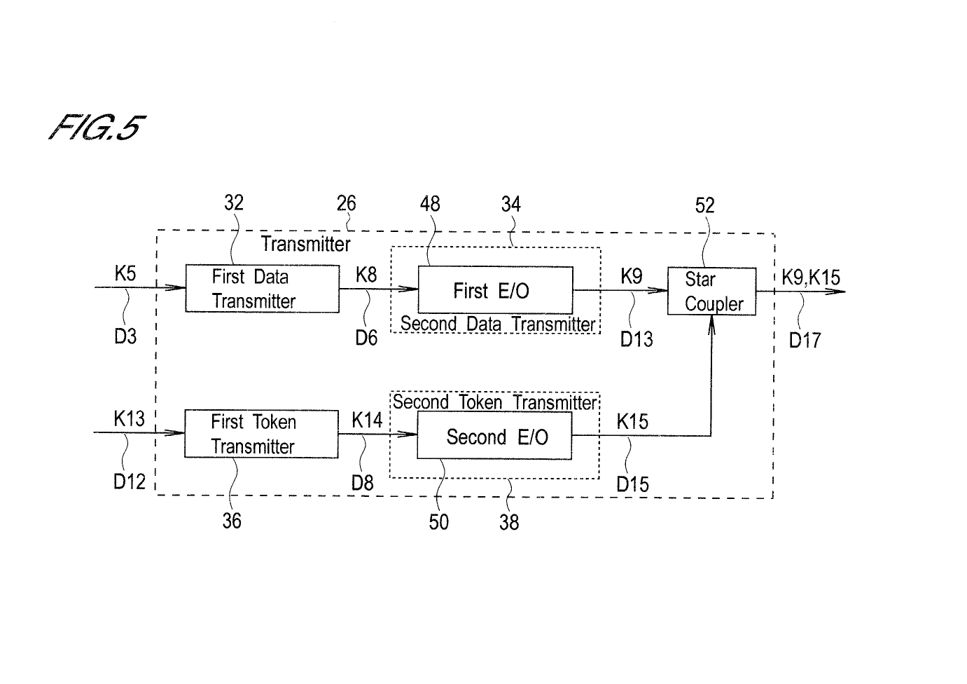

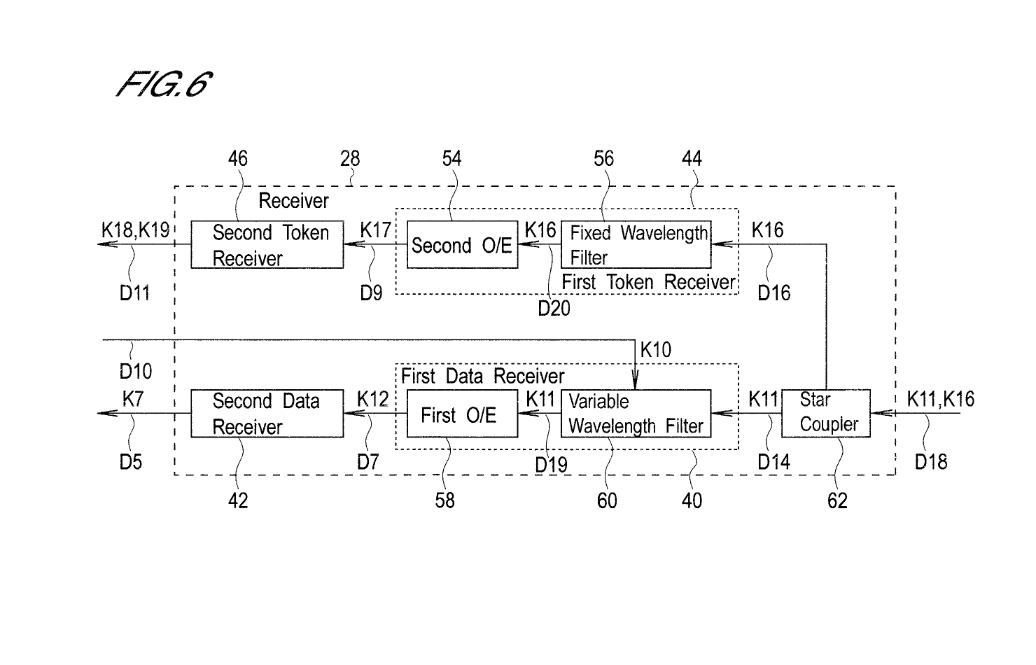

Next, the internal configuration of the terminal 12 and node 14 diagrammed in FIG. 1 is described with reference to FIGS. 4, 5, and 6. FIG. 4 is a block diagram of the internal configuration of the terminal and the node. FIG. 5 is a block diagram of the configuration of a transmitter. And FIG. 6 is a block diagram of the configuration of a receiver.

As diagrammed in FIG. 4, the terminal 12 is configured by a recipient input unit 20, a terminal transmitter 22, and a terminal receiver 24. The node 14 is configured by a transmitter 26, a receiver 28, and a connection processor 30.

As diagrammed in FIG. 5, the transmitter 26 is configured by a first data transmitter 32, a second data transmitter 34, a first token transmitter 36, a second token transmitter 38, and a star coupler 52. Of these, the second data transmitter 34 is configured by a first electric-to-optical conversion device (hereinafter called the first E/O) 48, while the second token transmitter 38 is configured by a second electric-to-optical conversion device (hereinafter called the second E/O) 50.

As diagrammed in FIG. 6, moreover, the receiver 28 is configured by a first data receiver 40, a second data receiver 42, a first token receiver 44, a second token receiver 46, and a star coupler 62. Of these, the first data receiver 40 is configured by a variable wavelength filter 60 and a first optical-to-electric conversion device (hereinafter called the first O/E) 58, while the first token receiver 44 is configured by a fixed wavelength filter 56 and a second optical-to-electric conversion device (hereinafter called the second O/E) 54.

Next, the connection relationships between the components configuring the terminals 12 and the nodes 14 are described. In the network system 10 are deployed connection circuits which are a first transmission path D1 to a 20th transmission path D20.

The first transmission path D1 connects between the recipient input unit 20 and the connection processor 30. The second transmission path D2 connects between the terminal transmitter 22 and the connection processor 30. The third transmission path D3 connects between the terminal transmitter 22 and the first data transmitter 32. The fourth transmission path D4 connects between the terminal receiver 24 and the connection processor 30. And the fifth transmission path D5 connects between the terminal receiver 24 and the second data receiver 42.

These transmission paths D1 to D5 configure the electrical circuit line Q1 indicated in FIG. 1.

The sixth transmission path D6 connects between the first data transmitter 32 and the first E/O 48. The seventh transmission path D7 connects between the first O/E 58 and the second data receiver 42. The eighth transmission path D8 connects between the first token transmitter 36 and the second E/O 50. The ninth transmission path D9 connects between the second O/E 54 and the second token receiver 46. The tenth transmission path D10 connects between the connection processor 30 and the variable wavelength filter 60. The 11th transmission path D11 connects between the connection processor 30 and the second token receiver 46. And the 12th transmission path D12 connects between the connection processor 30 and the first token receiver 36.

The 13th transmission path D13 connects between the first E/O 48 and the star coupler 52. The 14th transmission path D14 connects between the variable wavelength filter 60 and the star coupler 62. The 15th transmission path D15 connects between the second E/O 50 and the star coupler 52. The 16th transmission path D16 connects between the fixed wavelength filter 56 and the star coupler 62. The 17th transmission path D17 connects between the star coupler 52 and the star coupler 16 indicated in FIG. 1. And the 18th transmission path D18 connects between the star coupler 62 and the star coupler 16 indicated in FIG. 1.

These transmission paths D17 and D18 configure the light transmission path Q2 indicated in FIG. 1.

The 19th transmission path D19 connects between the variable wavelength filter 60 and the first O/E 58. And the 20th transmission path D20 connects between the fixed wavelength filter 56 and the second O/E 54.

The functions of the components configuring the terminal 12 are next described.

To the recipient input unit 20 is input the recipient number K1 (which might be a telephone number or a fax number, for example) of the terminal 12 at the data transmission destination. The recipient input unit 20 converts the input recipient number K1 to a recipient number signal K2 that is an electrical signal. After that has been done, the recipient input unit 20 sends the recipient number signal K2 to the first transmission path D1. This recipient number signal K2 is sent via that first transmission path D1 to the connection processor 30.

To the terminal transmitter 22 is input raw data K4 (such as audio or images, for example) output from the transmitting party (i.e. the user of the terminal 12). Upon receiving a transmission possible signal K3 over the second transmission path D2 from the connection processor 30, the terminal transmitter 22 converts the raw data K4 input to data K5 constituting an electrical signal. After that has been done, the terminal transmitter 22 sends the converted data K5 to the third transmission path D3. These data K5 are sent to the first data transmitter 32 via the third transmission path D3.

When a transmission not-possible signal K20 is received over the second transmission path D2 from the connection processor 30, however, the terminal transmitter 22 does not perform the operations described above.

To the terminal receiver 24 is input a reception possible signal K6 sent from the connection processor 30, via the fourth transmission path D4. Upon receiving a reception possible signal K6, the terminal receiver 24 prepares to receive data K7. Then the data K7 sent from the second data receiver 42 are input to the terminal receiver 24 via the fifth transmission path D5. These data K7 are an electrical signal. Upon receiving the data K7, the terminal receiver 24 converts those data K7 to the original raw data K22 format (such as audio or images, for example). After that has been done, the terminal receiver 24 outputs the converted raw data K22 to the terminal 12 user.

When the terminal receiver 24 receives a reception not possible signal K21 over the fourth transmission path D4 from the connection processor 30, however, it transmits a message to the terminal 12 user informing that a call connection with that terminal 12 is not possible.

Next, the functions of the components configuring the transmitter 26 of the node 14 are described.

The first data transmitter 32 is a transmitter that, after converting the data K5 received from the terminal 12 to first data K8 of a prescribed format, transmits those first data K8 to the second data transmitter 34.

More specifically, to the first data transmitter 32 are input, via the third transmission path D3, the data K5 sent from the terminal transmitter 22. Then the first data transmitter 32 subjects the input data K5 to primary modulation such as PSK modulation, converting the data K5 to first data K8 (electrical signal). What is meant by the prescribed format mentioned above is a data format obtained by such modulation. The first data transmitter 32, thereupon, sends the first data K8 obtained to the sixth transmission path D6. These first data K8 are sent to the second data transmitter 34 via the sixth transmission path D6.

The second data transmitter 34, after converting the first data K8 received from the first data transmitter 32 to second data K9 on any one of the data transmission channels, transmits those second data K9 to the communications network 18. The data transmission channels are configured so that one of n channels is assigned to each node 14 so that there is no redundancy.

In this embodiment, moreover, it is assumed that the data transmission channels described above have light wavelengths from λ₁ to λₙ, respectively. That is, the i'th channel is assumed to have the wavelength λᵢ (where i is a natural number from 1 to n).

Also, as described in the foregoing, the second data transmitter 34 is configured by a first E/O 48. This first E/O 48 converts the first data K8 received into second data K9 having one of the wavelengths from λ₁ to λₙ.

As described in the foregoing, to the first E/O 48 configuring the second data transmitter 34, the first data K8 sent from the first data transmitter 32 are input, via the sixth transmission path D6. The first E/O 48 converts the first data K8 input to second data K9 having one of the wavelengths from λ₁ to λₙ that is assigned beforehand. Accordingly, this second data K9 constitutes an optical signal. The first E/O 48 sends the second data K9 to the 13th transmission path D13. These second data K9 are sent via the 13th transmission path D13 to the star coupler 52. These second data K9, furthermore, are sent to the 17th transmission path D17 via the star coupler 52. These second data K9 are sent to the star coupler 16 indicated in FIG. 1 via the 17th transmission path D17.

The first token transmitter 36 produces a token packet K14 and transmits that token packet K14 to the second token transmitter 38.

To that first token transmitter 36 is input, via the 12th transmission path D12, a token packet transmission command signal K13 output from the connection processor 30. The first token transmitter 36, upon receiving the token packet transmission command signal K13, produces a token packet K14 that includes connection information and a token. The first token transmitter 36 thereupon sends the token packet K14 so produced to the eighth transmission path D8. The token packet K14 is sent via that eighth transmission path D8 to the second token transmitter 38. This token packet K14 is an electrical signal.

As was already described, moreover, there are four types of token packet, namely a communication request type, a communication possible reply type, a communication not possible reply type, and a reply confirmation type. As described earlier, these types are defined by connection information called type numbers. The first token transmitter 36, upon receiving a token packet transmission command signal K13, writes the type number designated by that token packet transmission command signal K13 in the type number block in the token packet K14. The recipient number signal K2 described earlier is also contained in the token packet transmission command signal K13 output from the connection processor 30. The first token transmitter 36 writes the transmission destination address corresponding to the recipient number signal K2 received to the transmission destination address block in the token packet K14. When there is no particular request from the connection processor 30, however, the first token transmitter 36 does not write a type number or a transmission destination address in the token packet.

The second token transmitter 38 converts the token packet K14 received from the first token transmitter 36 to a first token packet K15 for the connection establishing channel. The second token transmitter 38 transmits that first token packet K15 to the communications network. The (n+1)th channel, which differs from the data transmission channels, is used as the connection establishing channel.

In this embodiment, furthermore, the (n+1)th channel noted above is assumed to have the light wavelength λ₍ₙ₊₁₎. This λₙ₊₁ wavelength is a wavelength that differs from the wavelengths λ₁ to λₙ described earlier.

As described in the foregoing, the second token transmitter 38 is configured by a second E/O 50. This second E/O 50 is for converting the token packet K14 received to a first token packet K15 having a wavelength of λₙ₊₁.

To the second E/O 50 that configures the second token transmitter 38 is input, via the eighth transmission path D8, the token packet K14 output from the first token transmitter 36. The second E/O 50 converts the token packet K14 input to a first token packet K15 having the wavelength λₙ₊₁. The first token packet K15 is therefore an optical signal. After that has been done, the second token transmitter 38 sends that first token packet K15 to the 15th transmission path D15. The first token packet K15 is sent via that 15th transmission path D15 to the star coupler 52. The first token packet K15 is also sent via the star coupler 52 to the 17th transmission path D17. This first token packet K15 is sent via that 17th transmission path D17 to the star coupler 16 indicated in FIG. 1.

Next, the functions of the components configuring the receiver 28 of the node 14 are described.

The first data receiver 40 is a receiver that selects one of the data transmission channels and thereby receives second data K11 from the communications network 18. This first data receiver 40 converts those second data K11 to first data K12. The first data receiver 40 thereupon transmits those first data K12 to the second data receiver 42.

As described in the foregoing, in this embodiment, for the data transmission channels, the light wavelengths λ₁ to λₙ are used. The first data receiver 40 in this example is configured by a variable wavelength filter 60 and a first O/E 58. The variable wavelength filter 60 selects one of the wavelengths from λ₁ to λₙ and thereby receives the second data K11 from the communications network 18. The first O/E 58 converts the second data K11 sent from the variable wavelength filter 60 to first data K12.

The second data K11 output from the star coupler 16 indicated in FIG. 1 are input to the star coupler 62 via the 18th transmission path D18. These second data K11 are sent via the star coupler 62 to the 14th transmission path D14. Thereupon, these second data K11 are input via that 14th transmission path D14 to the variable wavelength filter 60.

To the variable wavelength filter 60 described above is input, via the tenth transmission path D10, a transmission origination channel selection signal K10 sent from the connection processor 30. This transmission origination channel selection signal K10 contains connection information having a type number of 2 or 4. This transmission origination channel selection signal K10 also contains information that is the transmission origination address noted earlier. The variable wavelength filter 60, upon receiving this transmission origination channel selection signal K10, selects a wavelength that is one of the wavelengths from λ₁ to λₙ, based on the transmission origination channel contained therein. That is, the variable wavelength filter 60 selects the data transmission channel assigned to the node 14 where the transmission of the second data K11 originated. The variable wavelength filter 60 functions as a filter for passing the second data K11 having the selected wavelength. Accordingly, the variable wavelength filter 60 is capable of selectively receiving second data K11 on a desired channel from the second data K11 on a plurality of channels input via the 14th transmission path D14.

The second data K11 received by the variable wavelength filter 60, after passing through the 19th transmission path D19, are input to the first O/E 58. The first O/E 58 converts the input second data K11 to first data K12 that constitute an electrical signal. These first data K12 are sent via the seventh transmission path D7 to the second data receiver 42.

The second data receiver 42 is a receiver that converts the first data K12 received from the first data receiver 40, that is, from the first O/E 58, to data K7, and transmits those data K7 to the terminal 12. The format of those data K7 will be a data format that can be received by the terminal receiver 24. The data K7 are transmitted via the fifth transmission path D5 to the terminal receiver 24.

The first token receiver 44 is a receiver that receives a first token packet K16 from the communications network 18, using the (n+1)th channel. The first token receiver 44 converts that first token packet K16 to a token packet K17, and transmits that token packet K17 to the second token receiver 46.

As described in the foregoing, in this embodiment, the light wavelength λₙ₊₁ is used for the (n+1)th channel. The first token receiver 44 in this example is configured by a fixed wavelength filter 56 and a second O/E 54. The fixed wavelength filter 56 is a filter that receives the first token packet K16 having the wavelength λₙ₊₁ from the communications network 18. The second O/E 54 is for converting the first token packet K16 sent from the fixed wavelength filter 56 to the token packet K17.

The first token packet K16 output from the star coupler 16 indicated in FIG. 1 is input via the 18th transmission path D18 to the star coupler 62. This first token packet K16 is sent via the star coupler 62 to the 16th transmission path D16. Thereupon, this first token packet K16 is input via that 16th transmission path D16 to the fixed wavelength filter 56.

The fixed wavelength filter 56 functions as a filter for passing the first token packet K16 having the wavelength λₙ₊₁. That is, the fixed wavelength filter 56 makes it possible to selectively receive the first token packet K16 having the wavelength λₙ₊₁. The first token packet K16 received by the fixed wavelength filter 56, after being output to the 20th transmission path D20, is received via that 20th transmission path D20 by the second O/E 54. In the second O/E 54, the first token packet K16 is converted to the token packet K17 that is an electrical signal. This token packet K17 is sent from the second O/E 54 to the ninth transmission path D9. This token packet K17 is thereupon sent via that ninth transmission path D9 to the second token receiver 46.

The second token receiver 46 is a receiver for extracting the token and the connection information relating to that second token receiver 46 from the token packet K17 received from the first token receiver 44, that is, from the second O/E 54. The second token receiver 46 then transmits the extracted token and connection information to the connection processor 30.

The second token receiver 46 verifies the transmission destination address contained in the received token packet K17. Let it be assumed that this transmission destination address is the address of the node 14 having that second token receiver 46. When that is so, the second token receiver 46 extracts the transmission destination address and type number contained in that token packet K17 as the connection information K19, and sends the extracted connection information K19 to the 11th transmission path D11. The connection information K19 is sent via that 11th transmission path D11 to the connection processor 30.

The second token receiver 46 also sends the sequence address contained in the received token packet K17 as the token K18 to the 11th transmission path D11. This token K18 is sent via that 11th transmission path D11 to the connection processor 30.

The connection processor 30 is a processor that, upon receiving a data transmission request from the terminal 12 connected thereto, causes the first token transmitter 36 to produce prescribed connection information. The connection processor 30 also, upon receiving the token K18 and the connection information K19 from the second token receiver 46, if it is possible to establish a connection, causes the first data receiver 40 connected to that connection processor 30 to select the data transmission channel assigned to the data transmission originating node 14.

More specifically, to the connection processor 30 is input, via the first transmission path D1, the recipient number signal K2 sent from the recipient input unit 20 of the terminal 12. The connection processor 30, by receiving the recipient number signal K2, accepts a data transmission request from the terminal 12. Thereupon, the connection processor 30 sends a communication request type token packet transmission command signal K13 to the 12th transmission path D12. Contained in this token packet transmission command signal K13 is the recipient number signal K2. This token packet transmission command signal K13 is sent via the 12th transmission path D12 to the first token transmitter 36. As described in the foregoing, the first token transmitter 36 produces a token packet K14 comprising connection information and a token, according to that token packet transmission command signal K13.

To the connection processor 30 is input, via the 11th transmission path D11, the token K18 or the connection information K19 sent from the second token receiver 46. The connection processor 30, in response to the received connection information K19 type number, performs one of the processing routines 1 to 4 indicated below.

Case 1 Where Type Number Is 1:

This connection information K19 is a message wherewith the transmission originating node 14 for this connection information K19 makes request to that transmission originating node 14 of that connection information K19 to establish a connection.

The connection processor 30 first extracts the transmission origination address from the received connection information K19. Next the connection processor 30, when the terminal 12 connected thereto is in a communication possible status, transmits a communication possible reply type token packet transmission command signal K13 to the 12th transmission path D12. That token packet transmission command signal K13 is sent via that 12th transmission path D12 to the first token transmitter 36. The first token transmitter 36, in response to that received token packet transmission command signal K13, produces a communication possible reply type token packet. In this case, the transmission origination address extracted by the connection processor 30 is written as the transmission destination address into the fourth block of that token packet.

There will also be cases where the terminal 12 connected to the connection processor 30 is in a communication not possible state because it is in use, etc. In such cases, the connection processor 30 transmits a communication not possible reply type token packet transmission command signal K13 to the 12th transmission path D12. That token packet transmission command signal K13 is sent via the 12th transmission path D12 to the first token transmitter 36. The first token transmitter 36, in response to the received token packet transmission command signal K13, produces a communication not possible replay type token packet. In that case, the transmission origination address extracted by the connection processor 30 is written into the fourth block of that token packet as the transmission destination address.

Case 2 Where Type Number Is 2:

This connection information K19 is a reply to the connection information K19 having the type number 1. That is, this connection information K19 is a message to the effect that the transmission originating node 14 for this connection information K19 will accept the request to establish a connection.

The connection processor 30 first extracts the transmission origination address from the received connection information K19. Next the connection processor 30 transmits a reply confirmation type token packet transmission command signal K13 to the 12th transmission path D12. This token packet transmission command signal K13 is sent via that 12th transmission path D12 to the first token transmitter 36. The first token transmitter 36, in response to the received token packet transmission command signal K13, produces a reply confirmation type token packet. In this case, the transmission origination address extracted by the connection processor 30 is written as the transmission destination address into the fourth block of that token packet.

The connection processor 30 also transmits a transmission origination channel selection signal K10 to the 10th transmission path D10. This transmission origination channel selection signal K10 is sent via that 10th transmission path D10 to the variable wavelength filter 60 of the first data receiver 40. In that transmission origination channel selection signal K10 is contained the transmission origination address extracted by the connection processor 30. As described earlier, the first data receiver 40 selects a prescribed channel based on the received transmission origination address.

In addition to transmitting the transmission possible signal K3 to the second transmission path D2, the connection processor 30 also transmits a reception possible signal K6 to the fourth transmission path D4. The transmission possible signal K3 is sent via the second transmission path D2 to the terminal transmitter 22. The reception possible signal K6 is sent via the fourth transmission path D4 to the terminal receiver 24.

Case 3 Where Type Number Is 3:

This connection information K19 is a reply to the connection information K19 having the type number 1. Specifically, this connection information K19 is a message to the effect that the transmission originating node 14 for that connection information K19 cannot accept the request to establish a connection.

In this case, the connection processor 30, in addition to transmitting a transmission not possible signal K20 to the second transmission path D2, transmits a reception not possible signal K21 to the fourth transmission path D4. The transmission not possible signal K20 is sent to the terminal transmitter 22 via the second transmission path D2. The reception not possible signal K21 is sent via the fourth transmission path D4 to the terminal receiver 24.

Case 4 Where Type Number Is 4:

This connection information K19 is a reply from the node 14 which received the connection information K19 having the type number 2.

The connection processor 30 first extracts the transmission origination address from the received connection information K19. Next the connection processor 30 transmits a transmission origination channel selection signal K10 to the 10th transmission path D10. This transmission origination channel selection signal K10 is sent via that 10th transmission path D10 to the first data receiver 40. Contained in this transmission origination channel selection signal K10 is the transmission origination address information extracted by the connection processor 30. As described in the foregoing, the first data receiver 40 selects the prescribed channel based on the received transmission origination address.

In addition to transmitting a transmission possible signal K3 to the second transmission path D2, the connection processor 30 also transmits a reception possible signal K6 to the fourth transmission path D4. The transmission possible signal K3 is sent via the second transmission path D2 to the terminal transmitter 22. The reception possible signal K6 is sent via the fourth transmission path D4 to the terminal receiver 24.

Next, the operations of the network system 10a diagrammed in FIG. 2 are described in detail, based on the operations of the components described in the foregoing.

It is assumed that each of the terminals 12a, 12b, and 12c, and each of the nodes 14a, 14b, and 14c configuring the network system 10a, have the configurations of the terminal 12 and node 14 diagrammed in FIG. 4, 5, and 6, respectively. In the description that follows, FIG. 2, 4, 5, and 6 are referenced as appropriate.

Because n =3, moreover, the light wavelengths λ₁, λ₂, and λ₃ are used for the data transmission channels. The wavelength λ₁ is assigned to the first node 14a, the wavelength λ₂ to the second node 14b, and the wavelength λ₃ to the third node 14c, respectively. The light wavelength λ₄ is used for the connection establishing channel. These wavelengths λ₁, λ₂, λ₃ and λ₄ are all different from one another.

It is further assumed that the token TK circulates between the nodes in the order of 14a, 14b, and 14c. In order to effect this circulation, the configuration is made beforehand so that a prescribed address is written to the sequence address block in the token packet sent out by each node. For the symbol representing the token, TK was used in FIG. 2, but K18 is used in FIG. 4 and FIG. 6.

The operation of the network system 10a when the first terminal 12a makes a data transmission to the second terminal 12b is now described.

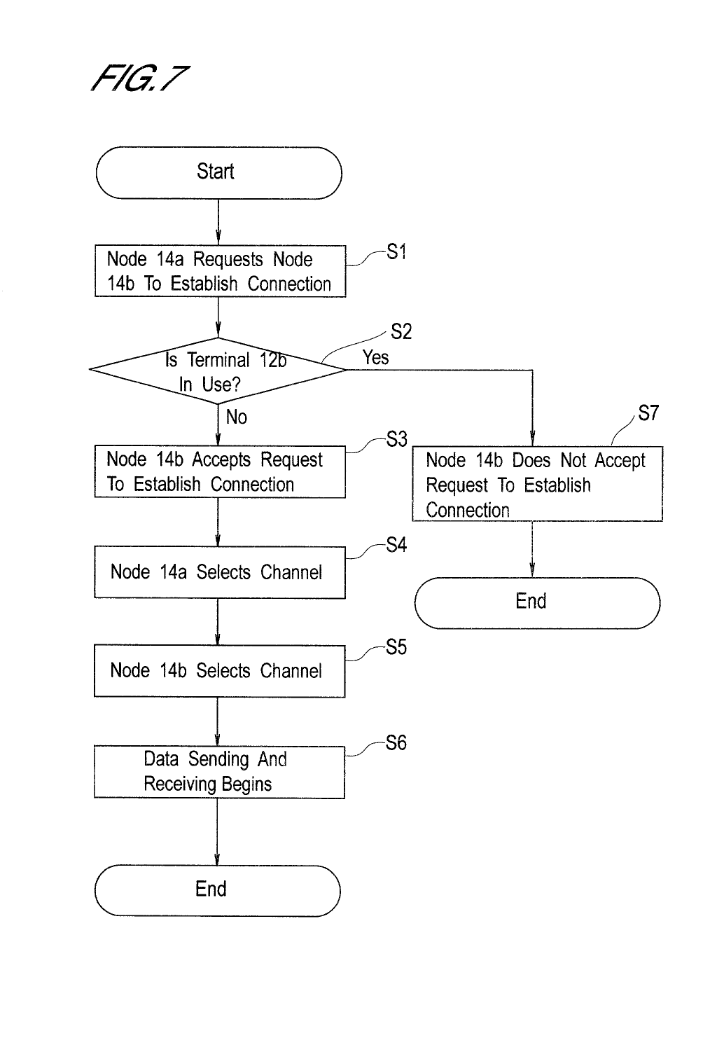

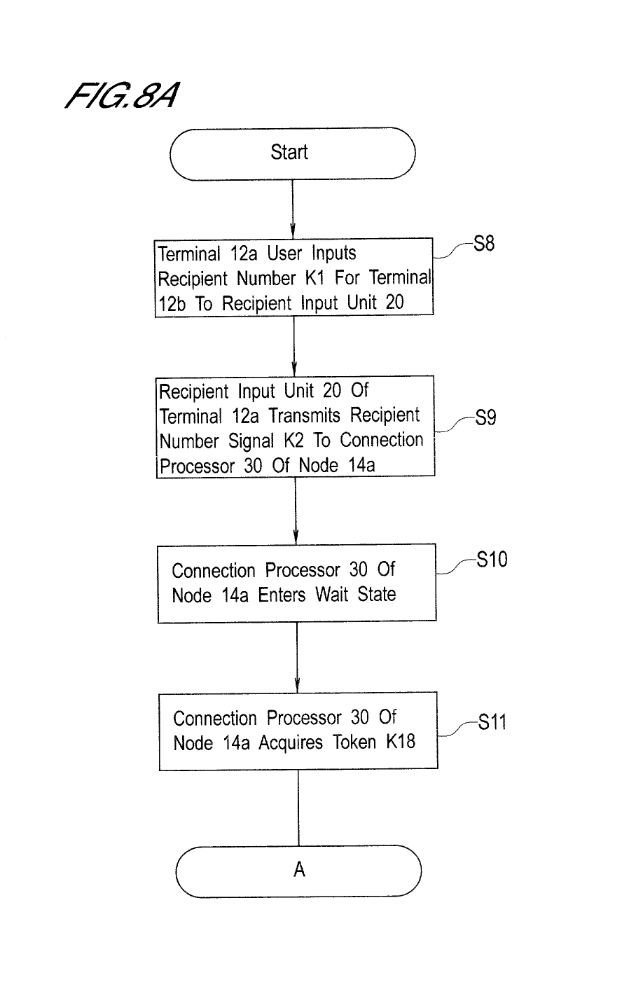

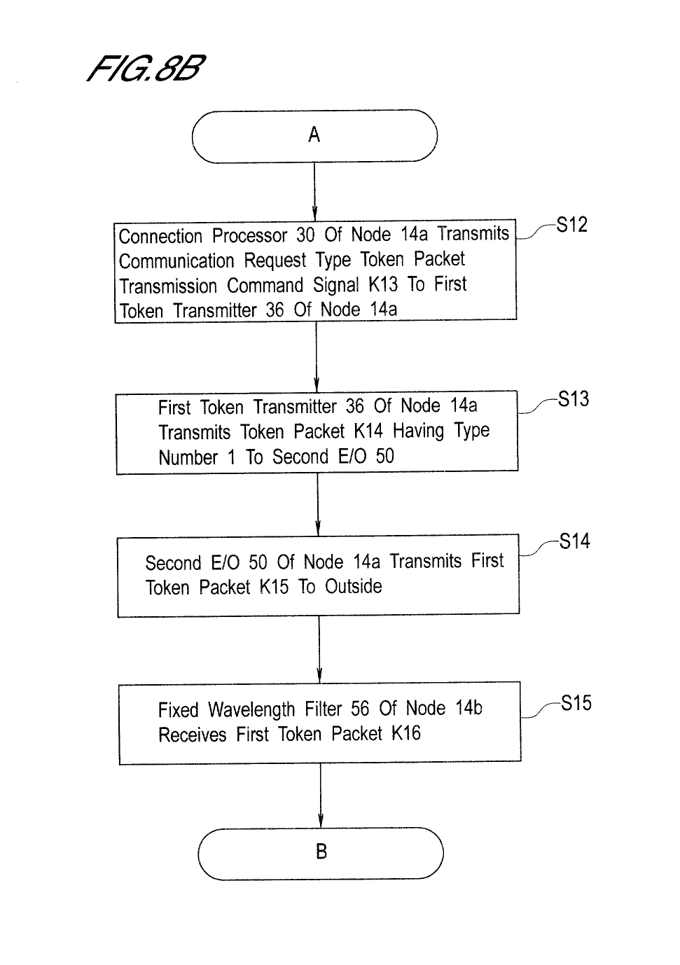

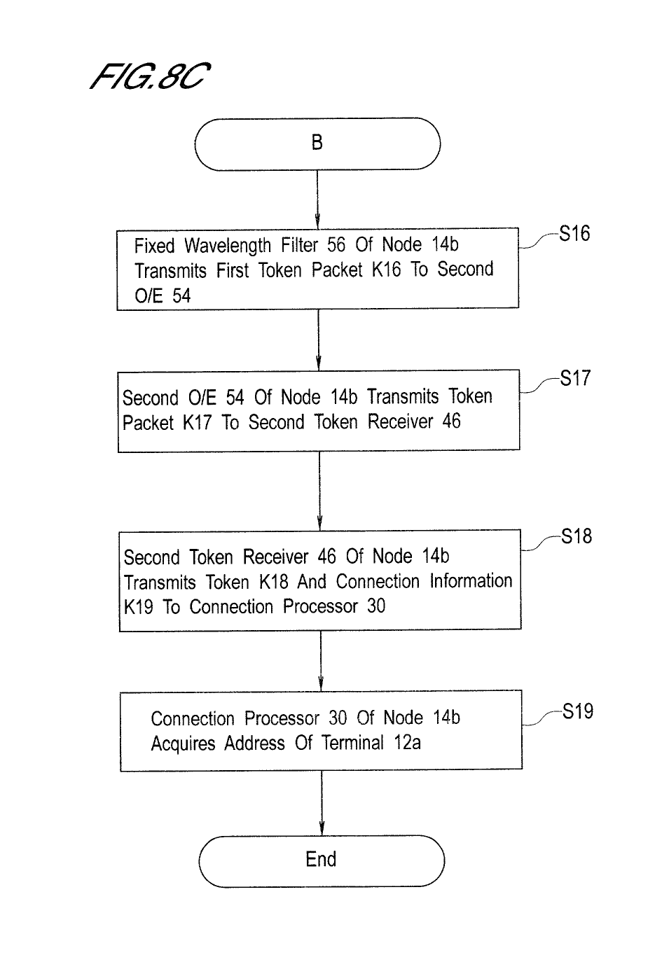

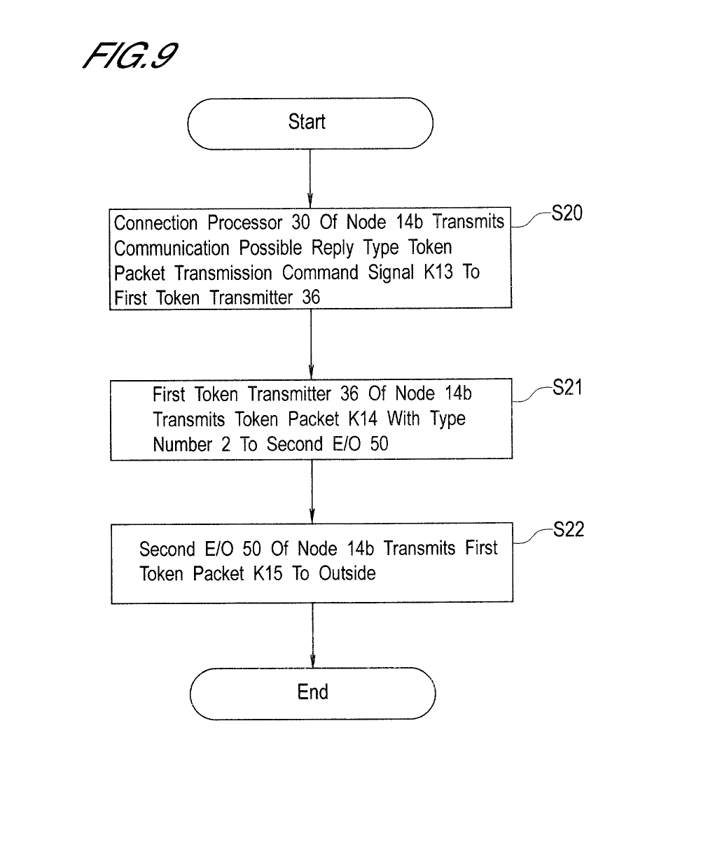

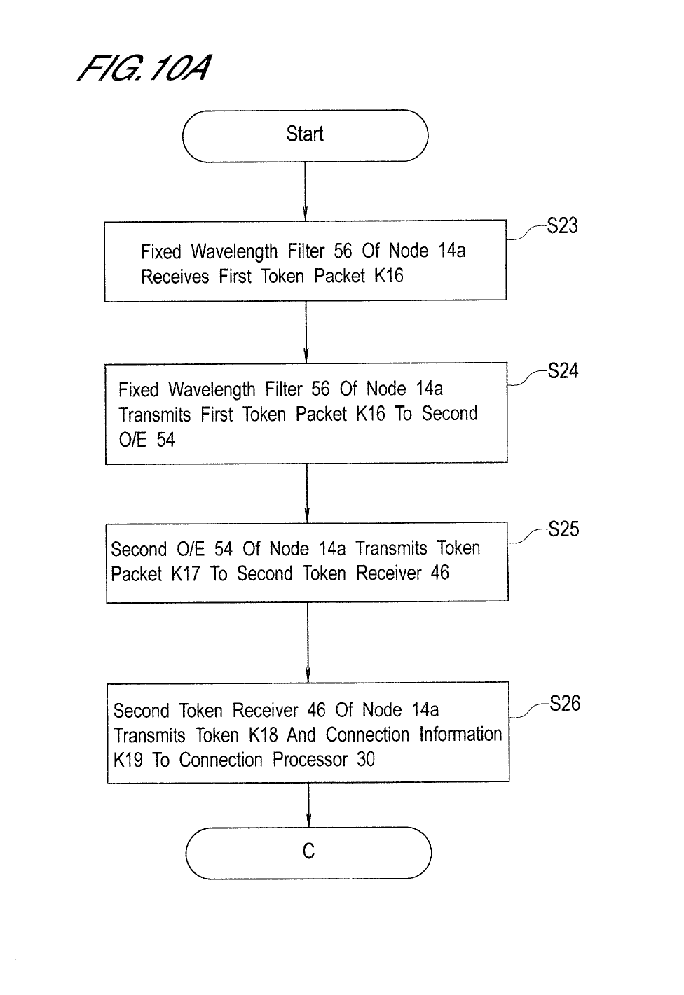

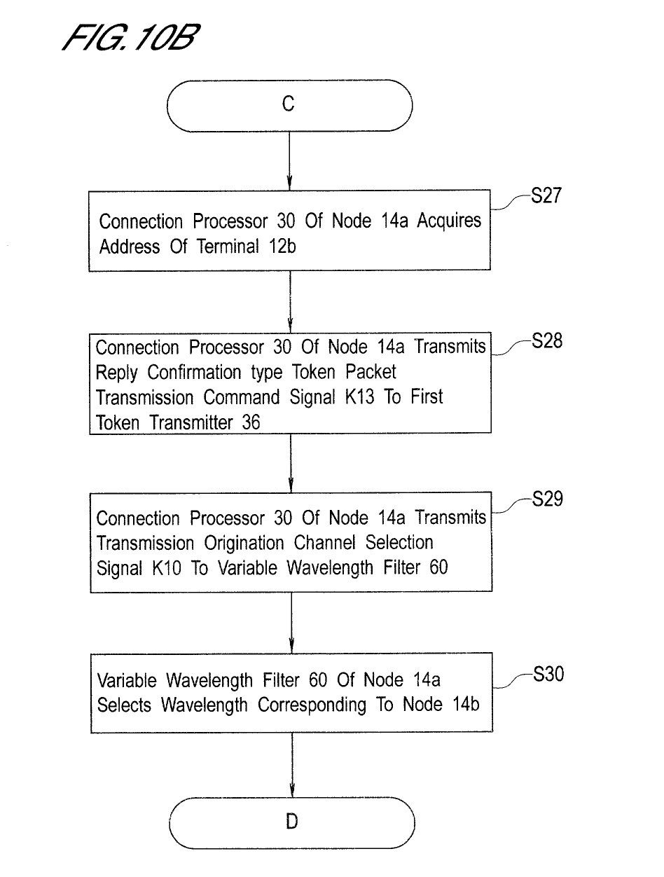

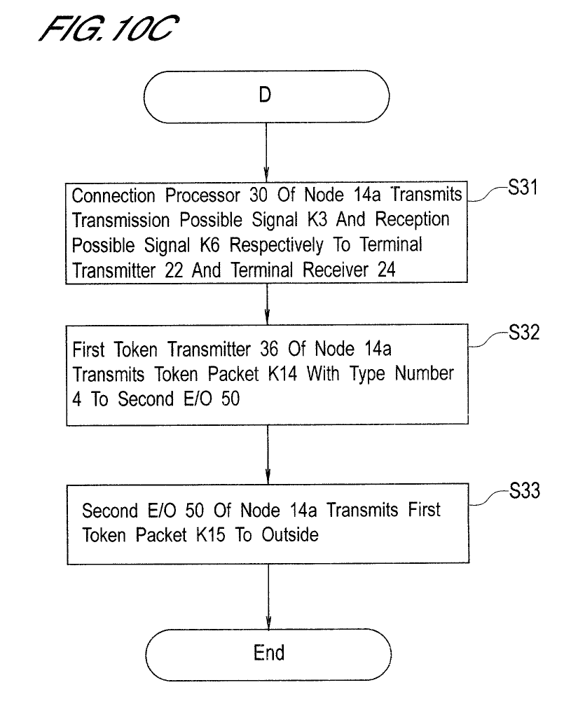

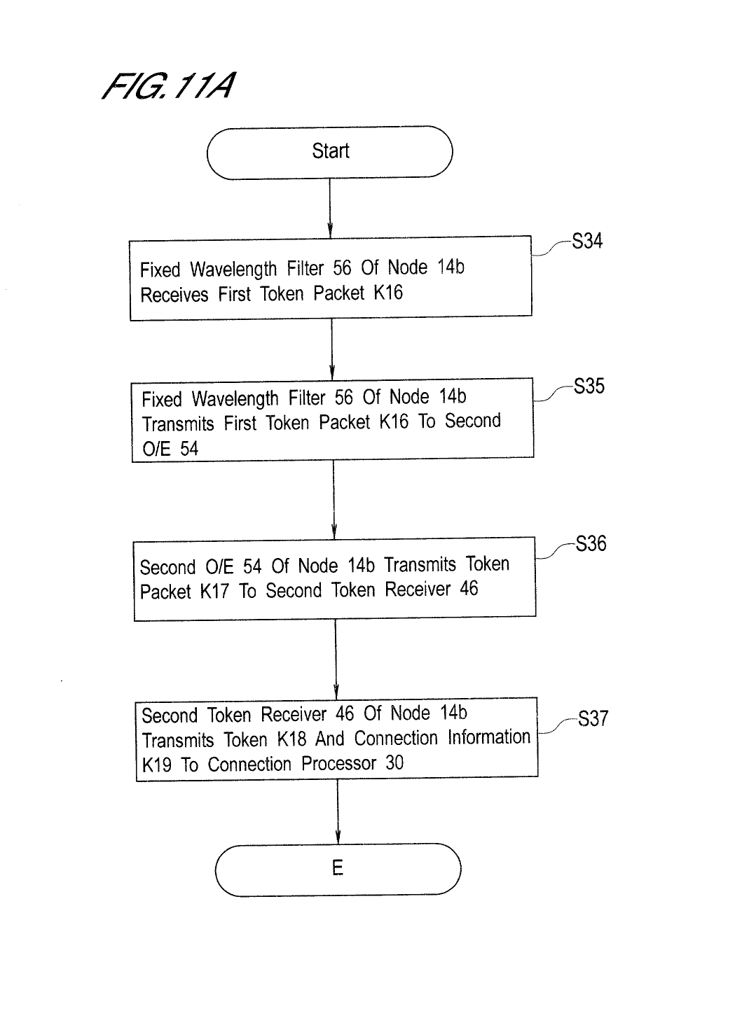

The overall flow is first described, making reference to FIG. 7. FIG. 7 is a flowchart for describing the operations of the network system 10a. Seven main steps are performed, as indicated below.

First, the first terminal 12a sends a data transmission request to the first node 14a. In step 1, the first node 14a that has received the data transmission request makes a request to the second node 14b to establish a connection (S1 in FIG. 7).

In step 2 that follows step 1, the second node 14b verifies whether or not the second terminal 12b is in use (S2 in FIG. 7). If the second terminal 12b is not in use, steps 3, 4, 5, and 6 described below are performed. If the second terminal 12b is in use, step 7 described below is performed.

In step 3 that follows step 2, the second node 14b accepts the request to establish a connection from the first node 14a (S3 in FIG. 7).

Next, in step 4 that follows step 3, the first node 14a selects a reception channel (S4 in FIG. 7). That is, the first node 14a matches the data reception channel with the data transmission channel assigned to the second node 14b.

Next, in step 5 that follows step 4, the second node 14b selects a reception channel (S5 in FIG. 7). That is, the second node 14b matches the data reception channel with the data transmission channel assigned to the first node 14a.

Next, in step 6 that follows step 5, data transmission and reception begin between the terminals 12a and 12b (S6 in FIG. 7).

And in step 7 that follows step 2, the second node 14b does not accept the request to establish a connection from the first node 14a (S7 in FIG. 7).

Each step is now described in turn.

Description of Step 1:

In describing step 1, FIGS. 8A, 8B, and 8C are referred to. These are flowcharts which indicate the procedures for making a connection establishment request.

First, the user of the first terminal 12a inputs the recipient number K1 for the second terminal 12b in the recipient input unit 20 of the first terminal 12a (S8 in FIG. 8A).

Next, the recipient input unit 20 of the first terminal 12a converts the input recipient number K1 to a recipient number signal K2 that is an electrical signal. Then the recipient input unit 20 transmits that recipient number signal K2 to the connection processor 30 of the first node 14a (S9 in FIG. 8A). That is, the recipient input unit 20 sends the recipient number signal K2 to the first transmission path D1. This recipient number signal K2 is sent via that first transmission path D1 to the connection processor 30 of the first node 14a.

Next, the connection processor 30 of the first node 14a enters a wait state while holding the received recipient number signal K2 (S10 in FIG. 8A). This recipient number signal K2 is temporarily stored in a memory (not shown) inside the connection processor 30.

Next, a token packet containing a token K18 is sent from the third node 14c to the first node 14a. The connection processor 30 of the first node 14a acquires that token K18 (S11 in FIG. 8A). The sequence address contained in this token K18 is the address of the first node 14a.

Following that, the connection processor 30 of the first node 14a transmits a communication request type token packet transmission command signal K13 to the first token transmitter 36 of the first node 14a (S12 in FIG. 8B). That is, the connection processor 30 sends the token packet transmission command signal K13 to the 12th transmission path D12. This token packet transmission command signal K13 is sent via that 12th transmission path D12 to the first token transmitter 36 of the first node 14a.

In the token packet transmission command signal K13 described above is contained the recipient number signal K2. The first token transmitter 36 of the first node 14a extracts the recipient number signal K2 from the token packet transmission command signal K13 received. The first token transmitter 36 then produces a token packet K14 based on that extracted recipient number signal K2. To the transmission destination address block in that token packet K14 is written the address of the second terminal 12b, that is, the address of the second node 14b. In the type number block of that token packet K14 is written the type number 1. The first token transmitter 36 transmits the token packet K14 so produced to the second E/O 50 of the first node 14a (S13 in FIG. 8B). That is, the first token transmitter 36 sends the token packet K14 to the eighth transmission path D8. This token packet K14 is sent via that eighth transmission path D8 to the second E/O 50 of the first node 14a. This token packet K14 is an electrical signal.

To the transmission origination address block in the token packet K14 is written the address of the first terminal 12a. And in the sequence address block in the token packet K14 is written the address of the second terminal 12b.

Next, the second E/O 50 of the first node 14a converts the received token packet K14 to a first token packet K15 having a wavelength of λ₄. This first token packet K15 is an optical signal. Then the second E/O 50 transmits the first token packet K15 to the outside (S14 in FIG. 8B). That is, the second E/O 50 sends the first token packet K15 to the 15th transmission path D15. This first token packet K15 is sent via that 15th transmission path D15 to the star coupler 52 of the first node 14a. The first token packet K15 is then sent from the star coupler 52 to the 17th transmission path D17. This first token packet K15 is sent via that 17th transmission path D17 to the star coupler 16 on the outside.

The first token packet K15 sent from the second E/O 50 of the first node 14a, after passing through the star coupler 16, is sent to the 18th transmission path D18 that is connected to the second node 14b. This first token packet K15 is sent via that 18th transmission path D18 to the star coupler 62 of the second node 14b. The first token packet K15 is input as the first token packet K16 to the star coupler 62 of the second node 14b. The first token packets K15 and K16 are the same entity.

The first token packet K16 is also sent from the star coupler 62 to the 16th transmission path D16. Then, after passing through the 16th transmission path D16, the first token packet K16 is received by the fixed wavelength filter 56 of the second node 14b (S15 in FIG. 8B). This fixed wavelength filter 56 selects the first token packet K16 having the wavelength λ₄ and sends that first token packet K16 to the second O/E 54 of the second node 14b (S16 in FIG. 8C). That is, the fixed wavelength filter 56 sends the first token packet K16 to the 20th transmission path D20. This first token packet K16 is sent via that 20th transmission path D20 to the second O/E 54 of the second node 14b.

Next, the second O/E 54 of the second node 14b converts the received first token packet K16 to a token packet K17 that is an electrical signal. Then the second O/E 54 transmits that token packet K17 to the second token receiver 46 of the second node 14b (S17 in FIG. 8C). That is, the second O/E 54 sends the token packet K17 to the ninth transmission path D9. This token packet K17 is sent via that ninth transmission path D9 to the second token receiver 46.

As described in the foregoing, the transmission destination address written in the token packet K17 is the address of the second terminal 12b. Therefore the second token receiver 46 of the second node 14b reads the connection information K19 out from the received token packet K17. As a result, the second token receiver 46 acquires “1” as the type number and the address of the first terminal 12a as the transmission origination address. Also, the sequence address written in that token packet K17 is the address of the second terminal 12b. Accordingly, the second node 14b acquires the token K18.

Next, the second token receiver 46 of the second node 14b transmits the token K18 and the connection information K19 to the connection processor 30 of the second node 14b (S18 in FIG. 8C). That is, the second token receiver 46 sends the token K18 and the connection information K19 to the 11th transmission path D11. The token K18 and the connection information K19 are sent via that 11th transmission path D11 to the connection processor 30 of the second node 14b.

Next, the connection processor 30 of the second node 14b extracts the transmission origination address from the received connection information K19. As a result, the connection processor 30 acquires the address of the first terminal 12a (S19 in FIG. 8C). The connection processor 30 also extracts the type number 1 from the received connection information K19. From these pieces of information the connection processor 30 of the second node 14b learns that the first terminal 12a is making a request to the terminal 12b to establish a connection.

Step 1 is therewith concluded. Following thereupon, as was described for step 2, a verification is made in the connection processor 30 of the second node 14b as to whether or not the second terminal 12b is in use. If the second terminal 12b is not in use, then steps 3, 4, 5, and 6 are performed. If the second terminal 12b is in use, step 7 is performed. The steps 3, 4, 5, and 6 are described next, in that order.

Description of Step 3:

In describing step 3, reference is made to FIG. 9. FIG. 9 is a flowchart indicating procedures implemented when the second node 14b accepts a request to establish a connection from the first node 14a.

First, the connection processor 30 of the second node 14b transmits a communication possible reply type token packet transmission command signal K13 to the first token transmitter 36 of the second node 14b (S20 in FIG. 9). That is, the connection processor 30 sends the token packet transmission command signal K13 described earlier to the 12th transmission path D12. That token packet transmission command signal K13 is sent via that 12th transmission path D12 to the first token transmitter 36. In this token packet transmission command signal K13, the address of the first terminal 12a is contained as the transmission destination address.

Next, based on that token packet transmission command signal K13 received, the first token transmitter 36 of the second node 14b produces a token packet K14. This token packet K14 is an electrical signal. In the type number block in this token packet K14 is written the type number 2. In the transmission destination address block in this token packet K14 is written the address of the first terminal 12a. In the sequence address block in this token packet K14 is written the address of the third terminal 12c. And in the transmission origination address block in this token packet K14 is written the address of the second terminal 12b.

Next, the first token transmitter 36 of the second node 14b transmits the produced token packet K14 having the type number 2 to the second E/O 50 of the second node 14b (S21 in FIG. 9). That is, the first token transmitter 36 sends the token packet K14 to the eighth transmission path D8. This token packet K14 is sent to the second E/O 50 via that eighth transmission path D8.

Next, the second E/O 50 of the second node 14b converts the received token packet K14 to a first token packet K15 of wavelength λ₄. This first token packet K15 is an optical signal. That second E/O 50 then transmits the first token packet K15 to the outside (S22 in FIG. 9). That is, the second E/O 50 sends the first token packet K15 to the 15th transmission path D15. This first token packet K15 is sent via that 15th transmission path D15 to the star coupler 52 of the second node 14b. This first token packet K15 is then sent from the star coupler 52 to the 17th transmission path D17. This first token packet K15 is sent via that 17th transmission path D17 to the star coupler 16 on the outside.

Description of Step 4:

In describing step 4, reference is made to FIGS. 10A, 10B, and 10C. These figures are flowcharts indicating mainly the procedures implemented when the first node 14a selects a data reception channel.

As described earlier, a first token packet K15 of the communication possible reply type is sent from the second node 14b to the outside. The first token packet K15 sent from the second E/O 50 of the second node 14b, after passing through the star coupler 16, is sent to the 18th transmission path D18 connected to the third node 14c. This first token packet K15 is sent via that 18th transmission path D18 to the star coupler 62 of the third node 14c. The first token packet K15 is input as the first token packet K16 to the star coupler 62 of the third node 14c. The first token packets K15 and K16 are the same entity.

At the third node 14c, the token K18 and the connection information K19 are acquired from the first token packet K16 received, as in the operation of the second node 14b described under step 1. As described earlier, however, the transmission destination address written in the first token packet K16 is the address of the first terminal 12a. For that reason, the third node 14c judges that the received connection information K19 is information intended for another node. Accordingly, the third node 14c sends a first token packet K15 such as is described below to the outside. That is, in this first token packet K15, the address of the second terminal 12b is written as the transmission origination address. Furthermore, in this first token packet K15, the address of the first terminal 12a is written as the sequence address. Furthermore, in this first token packet K15, the number 2 is written as the type number. And, furthermore, in this first token packet K15, the address of the first terminal 12a is written as the transmission destination address.

Thus a first token packet K15 of the communication possible reply type is sent to the outside from the third node 14c. This first token packet K15, after passing through the star coupler 16, is sent to the 18th transmission path D18 that is connected to the first node 14a. This first token packet K15 is sent via that 18th transmission path D18 to the star coupler 62 of the first node 14a. The first token packet K15 is input as the first token packet K16 to the star coupler 62 of the first node 14a. These token packets K15 and K16 are the same entity.

The first token packet K16 is also sent from the star coupler 62 to the 16th transmission path D16. Then, after passing through that 16th transmission path D16, the first token packet K16 is received by the fixed wavelength filter 56 of the first node 14a (S23 in FIG. 10A). This fixed wavelength filter 56 selects the first token packet K16 having the wavelength λ₄ and transmits that first token packet K16 to the second O/E 54 of the first node 14a (S24 in FIG. 10A). That is, the fixed wavelength filter 56 sends the first token packet K16 to the 20th transmission path D20. This first token packet K16 is sent via that 20th transmission path D20 to the second O/E 54 of the first node 14a.

Next, the second O/E 54 of the first node 14a converts the received first token packet K16 to a token packet K17 that is an electrical signal. The second O/E 54 then transmits that token packet K17 to the second token receiver 46 of the first node 14a (S25 in FIG. 10A). That is, the second O/E 54 sends the token packet K17 to the ninth transmission path D9. This token packet K17 is sent via that ninth transmission path D9 to the second token receiver 46.

As described earlier, the transmission destination address written in the token packet K17 is the address of the first terminal 12a. For that reason, the second token receiver 46 of the first node 14a reads out the connection information K19 from the received token packet K17. As a result, the second token receiver 46 acquires a type number of 2 and a transmission origination address that is the address of the second terminal 12b. Furthermore, the sequence address written in this token packet K17 is the address of the first terminal 12a. Accordingly, the first node 14a acquires the token K18.

Next, the second token receiver 46 of the first node 14a transmits the token K18 and the connection information K19 to the connection processor 30 of the first node 14a (S26 in FIG. 10A). That is, the second token receiver 46 sends the token K18 and the connection information K19 to the 11th transmission path D11. The token K18 and the connection information K19 are sent via that 11th transmission path D11 to the connection processor 30 of the first node 14a.

Next, the connection processor 30 of the first node 14a extracts the transmission origination address from the received connection information K19. As a result, the connection processor 30 acquires the address of the second terminal 12b (S27 in FIG. 10B). The connection processor 30 also extracts the type number 2 from the received connection information K19. From these pieces of information, the connection processor 30 of the first node 14a learns that communications are possible between itself and the second terminal 12b.

Next, the connection processor 30 of the first node 14a transmits a reply confirmation type token packet transmission command signal K13 to the first token transmitter 36 of the second node 14b (S28 in FIG. 10B). That is, the connection processor 30 sends the token packet transmission command signal K13 described earlier to the 12th transmission path D12. This token packet transmission command signal K13 is sent via that 12th transmission path D12 to the first token transmitter 36. In this token packet transmission command signal K13, the address of the second terminal 12b is contained as the transmission destination address.

The connection processor 30 of the first node 14a also transmits a transmission origination channel selection signal K10 to the variable wavelength filter 60 of the first node 14a (S29 in FIG. 10B). That is, the connection processor 30 sends the transmission origination channel selection signal K10 to the tenth transmission path D10. This transmission origination channel selection signal K10 is sent via that tenth transmission path D10 to the variable wavelength filter 60. In this transmission origination channel selection signal K10 is contained the address information for the second terminal 12b.

Next, based on the transmission origination channel selection signal K10 received, the variable wavelength filter 60 of the first node 14a selects the wavelength corresponding to the second node 14b (S30 in FIG. 10B). That is, the variable wavelength filter 60 selects the wavelength λ₂. As a result, at the variable wavelength filter 60 of the first node 14a, it becomes possible to selectively receive data of wavelength λ₂.

The connection processor 30 of the first node 14a also transmits a transmission possible signal K3 and a reception possible signal K6 to the terminal transmitter 22 and the terminal receiver 24, respectively (S31 in FIG. 10). That is, the connection processor 30 sends the transmission possible signal K3 to the second transmission path D2 and sends the reception possible signal K6 to the fourth transmission path D4. The transmission possible signal K3 is sent via the second transmission path D2 to the terminal transmitter 22 of the first terminal 12a. And the reception possible signal K6 is sent via the fourth transmission path D4 to the terminal receiver 24 of the first terminal 12a.

Next, the first token transmitter 36 of the first node 14a produces a token packet K14 based on the received token packet transmission command signal K13. This token packet K14 is an electrical signal. In the type number block in this token packet K14 is written the type number 4. In the transmission destination address block of this token packet K14 is written the address of the second terminal 12b. In the sequence address block of this token packet K14 is written the address of the second terminal 12b. And in the transmission origination address block in this token packet K14 is written the address of the first terminal 12a.

Next, the first token transmitter 36 of the first node 14a transmits the produced token packet K14 having the type number 4 to the second E/O of the first node 14a (S32 in FIG. 10C). That is, the first token transmitter 36 sends the token packet K14 to the eighth transmission path D8. This token packet K14 is sent via that eighth transmission path D8 to the second E/O 50.

Next, the second E/O 50 of the first node 14a converts the received token packet K14 to a first token packet K15 having the wavelength ₄. This first token packet K15 is an optical signal. The second E/O 50 then transmits that first token packet K15 to the outside (S33 in FIG. 10C). That is, the second E/O 50 sends the first token packet K15 to the 15th transmission path D15. This first token packet K15 is sent via that 15th transmission path DIS to the star coupler 52 of the first node 14a. That first token packet K15 is then sent from the star coupler 52 to the 17th transmission path D17. This first token packet K15 is sent via that 17th transmission path D17 to the star coupler 16 on the outside.

Description of Step 5:

In describing step 5, FIGS. 11A and 11B are referred to. These figures are flowcharts that mainly indicate procedures implemented when the second node 14b selects a data reception channel.

The first token packet K15 output from the second E/O 50 of the first node 14a, after passing through the star coupler 16, is sent to the 18th transmission path D18 that is connected to the second node 14b. This first token packet K15 is sent via that 18th transmission path D18 to the star coupler 62 of the second node 14b. The first token packet K15 is input as the first token packet K16 to the star coupler 62 of the second node 14b. The first token packets K15 and K16 are the same entity.

The first token packet K16 is the sent from the star coupler 62 to the 16th transmission path D16. Then, after passing through that 16th transmission path D16, the first token packet K16 is received by the fixed wavelength filter 56 of the second node 14b (S34 in FIG. 11). This fixed wavelength filter 56 selects the first token packet K16 having the wavelength λ₄ and transmits that first token packet K16 to the second O/E 54 of the second node 14b (S35 in FIG. 11A). That is, the fixed wavelength filter 56 sends the first token packet K16 to the 20th transmission path D20. This first token packet K16 is sent via that 20th transmission path D20 to the second O/E 54 of the second node 14b.

Next, the second O/E 54 of the second node 14b converts the received first token packet K16 to a token packet K17 that is an electrical signal. The second O/E 54 then transmits that token packet K17 to the second token receiver 46 of the second node 14b (S36 in FIG. 11A). That is, the second O/E 54 sends the token packet K17 to the ninth transmission path D9. This token packet K17 is sent via that ninth transmission path D9 to the second token receiver 46.

As described in the foregoing, the transmission destination address written in the token packet K17 is the address of the second terminal 12b. Accordingly, the second token receiver 46 of the second node 14b reads out the connection information K19 from the received token packet K17. As a result, the second token receiver 46 acquires a type number of 4 and a transmission origination address that is the address of the first terminal 12a. The sequence address written in this token packet K17 is the address of the second terminal 12b. Accordingly, the second node 14b acquires the token K18.

Next, the second token receiver 46 of the second node 14b transmits the token K18 and the connection information K19 to the connection processor 30 of the second node 14b (S37 in FIG. 11A). That is, the second token receiver 46 sends the token K18 and the connection information K19 to the 11th transmission path D1. The token K18 and the connection information K19 are sent via that 11th transmission path D1 to the connection processor 30 of the second node 14b.

Next, the connection processor 30 of the second node 14b extracts the transmission origination address from the received connection information K19. As a result, the connection processor 30 acquires the address of the first terminal 12a (S38 in FIG. 11B). The connection processor 30 also extracts the type number 4 from the received connection information K19. From these pieces of information, the connection processor 30 of the second node 14b learns that the first terminal 12a is requesting that a data reception channel be established with the second terminal 12b.

Next, the connection processor 30 of the second node 14b transmits a transmission origination channel selection signal K10 to the variable wavelength filter 60 of the second node 14b (S39 in FIG. 11B). That is, the connection processor 30 sends the transmission origination channel selection signal K10 to the tenth transmission path D10. This transmission origination channel selection signal K10 is sent via that tenth transmission path D10 to the variable wavelength filter 60. This transmission origination channel selection signal K10 contains address information for the first terminal 12a.

Next, the variable wavelength filter 60 of the second node 14b, based on the received transmission origination channel selection signal K10, selects a wavelength corresponding to the first node 14a (S40 in FIG. 11B). That is, the variable wavelength filter 60 selects the wavelength λ₁. As a result, the variable wavelength filter 60 of the second node 14b is able to selectively receive data of wavelength λ₁.

The connection processor 30 of the second node 14b transmits a transmission possible signal K3 and a reception possible signal K6 to the terminal transmitter 22 and the terminal receiver 24, respectively (S41 in FIG. 11B). That is, the connection processor 30 sends the transmission possible signal K3 to the second transmission path D2 and the reception possible signal K6 to the fourth transmission path D4. The transmission possible signal K3 is sent via the second transmission path D2 to the terminal transmitter 22 of the second terminal 12b. And the reception possible signal K6 is sent via the fourth transmission path D4 to the terminal receiver 24 of the second terminal 12b.

Thus a connection is established between the first node 14a and the second node 14b by the step described above.

Description of Step 6:

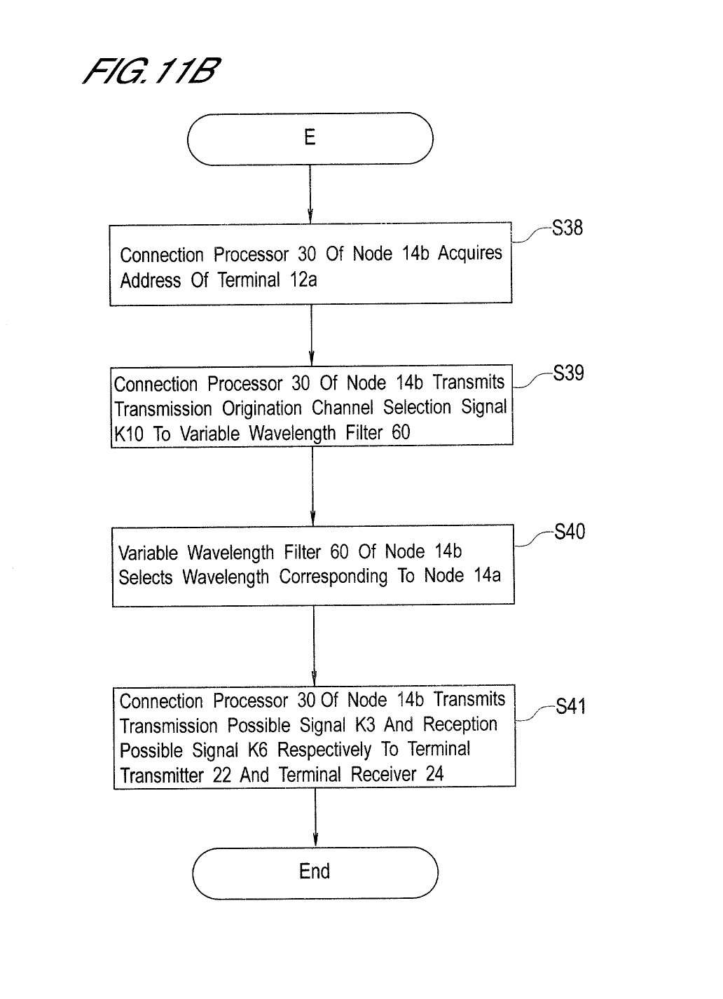

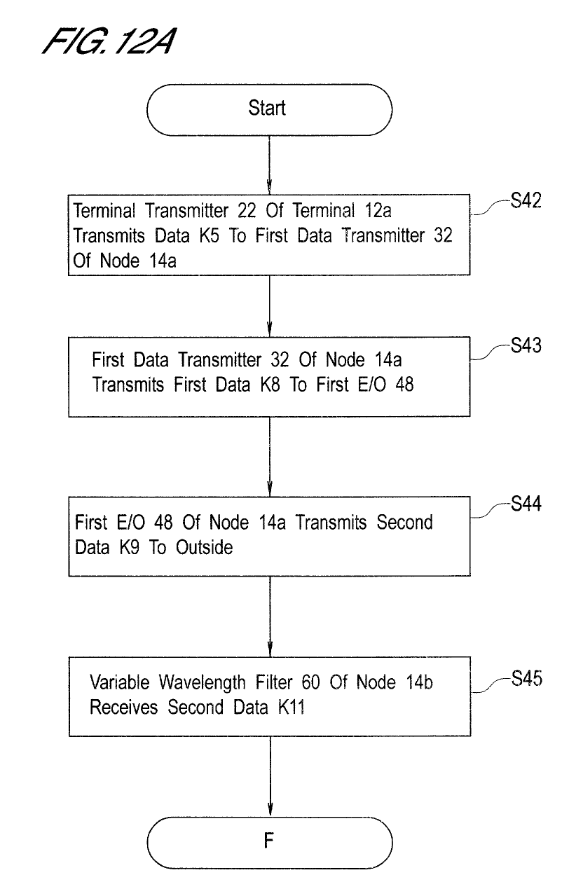

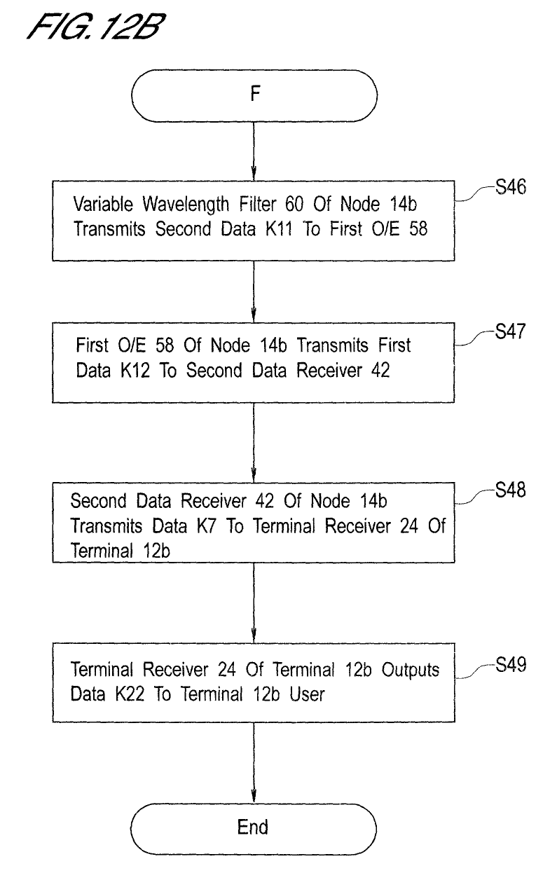

In describing step 6, reference is made to FIGS. 12A, 12B, 13A, and 13B. These figures are flowcharts that indicate procedures implemented for sending and receiving data between the terminals 12a and 12b. FIG. 12 indicates the procedures for transmitting data from the first terminal 12a to the second terminal 12b. FIG. 13 indicates procedures for receiving data at the first terminal 12a from the second terminal 12b.

First is described the case where data are transmitted from the first terminal 12a to the second terminal 12b.

First, the user of the first terminal 12a inputs raw data K4 consisting of audio or images or the like to the terminal transmitter 22 of the first terminal 12a. As was described under step 4, the terminal transmitter 22 of the first terminal 12a receives a transmission possible signal K3 from the connection processor 30 of the first node 14a. Accordingly, that terminal transmitter 22 replies to the received transmission possible signal K3 and begins processing the raw data K4. More specifically, this terminal transmitter 22 converts the input raw data K4 to data K5 that are an electrical signal. Then this terminal transmitter 22 transmits the data K5 to the first data transmitter 32 of the first node 14a (S42 in FIG. 12A). That is, the terminal transmitter 22 sends the data K5 to the third transmission path D3. These data K5 are sent via that third transmission path D3 to the first data transmitter 32 of the first node 14a.

Next, the first data transmitter 32 of the first node 14a converts the received data K5 to first data K8 in a prescribed format. Then this first data transmitter 32 transmits those first data K8 to the first E/O 48 of the first node 14a (S43 in FIG. 12A). That is, the first data transmitter 32 sends the first data K8 to the sixth transmission path D6. These first data K8 are sent via that sixth transmission path D6 to the first E/O 48.

Next, the first E/O 48 of the first node 14a converts the received first data K8 to second data K9 having a wavelength of λ₁. These second data K9 are an optical signal. Then the first E/O 48 transmits the second data K9 to the outside (S44 in FIG. 12A). That is, the first E/O 48 sends the second data K9 to the 13th transmission path D13. These second data K9 are sent via that 13th transmission path D13 to the star coupler 52 of the first node 14a. These second data K9 are then sent from the star coupler 52 to the 17th transmission path D17. These second data K9 are sent via that 17th transmission path D17 to the star coupler 16 on the outside.

The second data K9 sent from the first node 14a, after passing through the star coupler 16, are sent to the 18th transmission path D18 that is connected to the second node 14b. These second data K9 are sent via that 18th transmission path D18 to the star coupler 62 of the second node 14b. The second data K9 are input as second data K11 in the star coupler 62 of the second node 14b. The second data K9 and K11 are the same data.

The second data K11 are then sent from the star coupler 62 to the 14th transmission path D14. Then, after passing through the 14th transmission path D14, the second data K11 are received by the variable wavelength filter 60 of the second node 14b (S45 in FIG. 12A). This variable wavelength filter 60 selects the second data K11 of wavelength λ₁ and transmits these second data K11 to the first O/E 58 of the second node 14b (S46 in FIG. 12B). That is, the variable wavelength filter 60 sends the second data K11 to the 19th transmission path D19. These second data K11 are sent via that 19th transmission path D19 to the first O/E 58 of the second node 14b.

Next, the first O/E 58 of the second node 14b converts the received second data K11 to first data K12 that are an electrical signal. The first O/E 58 then transmits these first data K12 to the second data receiver 42 of the second node 14b (S47 in FIG. 12B). That is, the first O/E 58 sends the first data K12 to the seventh transmission path D7. These first data K12 are sent via that seventh transmission path D7 to the second data receiver 42.

Next, the second data receiver 42 of the second node 14b converts the received first data K12 to data K7. The second data receiver 42 then transmits these data K7 to the terminal receiver 24 of the second terminal 12b (S48 in FIG. 12B). That is, the second data receiver 42 sends the data K7 to the fifth transmission path D5. These data K7 are sent via that fifth transmission path D5 to the terminal receiver 24.

As was described under step 5, the terminal receiver 24 of the second terminal 12b receives the reception possible signal K6 from the connection processor 30 of the second node 14b. This terminal receiver 24 replies to the received reception possible signal K6 and begins receiving the data K7. Next, the terminal receiver 24 of the second terminal 12b converts the received data K7 to the original raw data K22 consisting of audio or images, etc. This terminal receiver 24 then outputs these raw data K22 to the user of the second terminal 12b (S49 in FIG. 12B).

Next described is the case where data are transmitted from the second terminal 12b to the first terminal 12a.

First, the user of the first terminal 12b inputs raw data K4 consisting of audio or images or the like to the terminal transmitter 22 of the second terminal 12b. As was described for step 5, the terminal transmitter 22 of the second terminal 12b receives a transmission possible signal K3 from the connection processor 30 of the second node 14b. Accordingly, this terminal transmitter 22 responds to the transmission possible signal K3 received and begins processing the raw data K4. More specifically, this terminal transmitter 22 converts the input raw data K4 to data K5 that are an electrical signal. This terminal transmitter 22 then transmits those data K5 to the first data transmitter 32 of the second node 14b (S50 in FIG. 13A). Specifically, the terminal transmitter 22 sends the data K5 to the third transmission path D3. These data K5 are sent via that third transmission path D3 to the first data transmitter 32 of the second node 14b.

Next, the first data transmitter 32 of the second node 14b converts the received data K5 to first data K8 in a prescribed format. This first data transmitter 32 then transmits those first data K8 to the first E/O 48 of the second node 14b (S51 in FIG. 13A). That is, the first data transmitter 32 sends the first data K8 to the sixth transmission path D6. These first data K8 are sent via that sixth transmission path D6 to the first E/O 48.

Next, the first E/O 48 of the second node 14b converts the received first data K8 to second data K9 having the wavelength λ₂. These second data K9 are an optical signal. This first E/O 48 then transmits the second data K9 to the outside (S52 in FIG. 13A). That is, the first E/O 48 sends the second data K9 to the 13th transmission path D13. These second data K9 are sent via that 13th transmission path D13 to the star coupler 52 of the second node 14b. These second data K9 are also sent from the star coupler 52 to the 17th transmission path D17. These second data K9 are sent via that 17th transmission path D17 to the star coupler 16 on the outside.

The second data K9 sent from the second node 14b, after passing through the star coupler 16, are sent to the 18th transmission path D18 that is connected to the first node 14a. These second data K9 are sent via that 18th transmission path D18 to the star coupler 62 of the first node 14a. The second data K9 are input as second data K11 to the star coupler 62 of the first node 14a. The second data K9 and K11 are the same data.

The second data K11 are also sent from the star coupler 62 to the 14th transmission path D14. The second data K11, after passing through that 14th transmission path D14, are received by the variable wavelength filter 60 of the first node 14a (S53 in FIG. 13A). This variable wavelength filter 60 selects the second data K11 of wavelength λ₂ and transmits those second data K11 to the first O/E 58 of the first node 14a (S54 in FIG. 13B). That is, the variable wavelength filter 60 sends the second data K11 to the 19th transmission path D19. These second data K11 are sent via that 19th transmission path D19 to the first O/E 58 of the first node 14a.

Next, the first O/E 58 of the first node 14a converts the received second data K11 to first data K12 that are an electrical signal. The first O/E 58 then transmits these first data K12 to the second data receiver 42 of the first node 14a (S55 in FIG. 13B). That is, the first O/E 58 sends the first data K12 to the seventh transmission path D7. These first data K12 are sent via that seventh transmission path D7 to the second data receiver 42.

Next, the second data receiver 42 of the first node 14a converts the received first data K12 to data K7. The second data receiver 42 then transmits these data K7 to the terminal receiver 24 of the first terminal 12a (S56 in FIG. 13B). That is, the second data receiver 42 sends the data K7 to the fifth transmission path D5. These data K7 are sent via that fifth transmission path D5 to the terminal receiver 24.

As was described under step 4, the terminal receiver 24 of the first terminal 12a receives a reception possible signal K6 from the connection processor 30 of the first node 14a. This terminal receiver 24 replies to that received reception possible signal K6 and begins receiving the data K7. Next, the terminal receiver 24 of the first terminal 12a converts the received data K7 to the original data K22 consisting of audio and images, etc. This terminal receiver 24 then outputs these raw data K22 to the user of the first terminal 12a (S57 in FIG. 13B).

As described in the foregoing, data are sent back and forth between the first terminal 12a and the second terminal 12b. When the data exchange is concluded, the connection between the first node 14a and the second node 14b is released.

Next is described step 7 which is performed when it has been verified that the second terminal 12b is in use.

Description of Step 7:

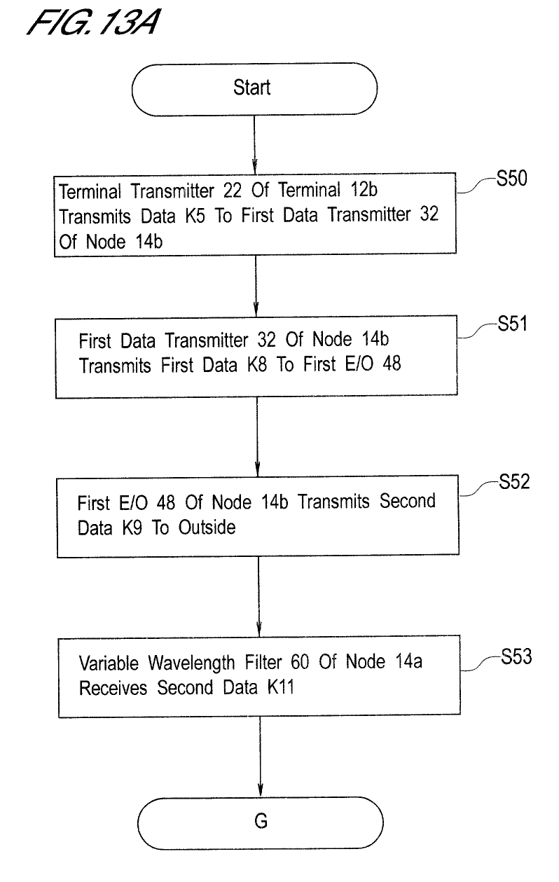

In describing step 7, reference is made to FIGS. 14A, 14B, and 14C. These figures are flowcharts indicating procedures implemented when the second node 14b does not accept a request to establish a connection from the first node 14a.

First, the connection processor 30 of the second node 14b transmits a communication not possible reply type token packet transmission command signal K13 to the first token transmitter 36 of the second node 14b (S58 in FIG. 14A). That is, the connection processor 30 sends the token packet transmission command signal K13 described earlier to the 12th transmission path D12. This token packet transmission command signal K13 is sent via that 12th transmission path D12 to the first token transmitter 36. In this token packet transmission command signal K13, the address of the first terminal 12a is contained as the transmission destination address.

Next, the first token transmitter 36 of the second node 14b, based on the received token packet transmission command signal K13, produces a token packet K14. This token packet K14 is an electrical signal. In the type number block of this token packet K14 is written the type number 3. In the transmission destination address block of this token packet K14 is written the address of the first terminal 12a. In the sequence address block of this token packet K14 is written the address of the third terminal 12c. And in the transmission origination address of this token packet K14 is written the address of the second terminal 12b.

Next, the first token transmitter 36 of the second node 14b transmits the produced token packet K14 having the type number 3 to the second E/O 50 of the second node 14b (S59 in FIG. 14A). That is, the first token transmitter 36 sends the token packet K14 to the eighth transmission path D8. This token packet K14 is sent via that eighth transmission path D8 to the second E/O 50.

Next, the second E/O 50 of the second node 14b converts the received token packet K14 to a first token packet K15 having the wavelength λ₄. This first token packet K15 is an optical signal. Then this second E/O 50 transmits the first token packet K15 to the outside (S60 in FIG. 14A). That is, the second E/O 50 sends the first token packet K15 to the 15th transmission path D15. This first token packet K15 is sent via that 15th transmission path D15 to the star coupler 52 of the second node 14b. This first token packet K15 is then sent from the star coupler 52 to the 17th transmission path D17. This first token packet K15 is sent via that 17th transmission path D17 to the star coupler 16 on the outside.

Thus a token packet K15 of the communication not possible reply type is sent from the second node 14b to the outside. The first token packet K15 sent from the second E/O 50 of the second node 14b, after passing through the star coupler 16, is sent to the 18th transmission path D18 that is connected to the third node 14c. This first token packet K15 is sent to the star coupler 62 of the third node 14c via that 18th transmission path D18. The first token packet K15 is input as the first token packet K16 to the star coupler 62 of the third node 14c. The first token packets K15 and K15 are the same entity.

At the third node 14c, the token K18 and the connection information K19 are acquired from the received first token packet K16. As described earlier, however, the transmission destination address written in the first token packet K16 is the address of the first terminal 12a. For that reason, the third node 14c judges that the received connection information 19 is information that is intended for another node. Accordingly, the third node 14c sends a first token packet K15 like that described below to the outside. That is, in this first token packet K15, the address of the second terminal 12b is written as the transmission origination address. In this first token packet K15, furthermore, the address of the first terminal 12a is written as the sequence address. In this first token packet K15, furthermore, the number 3 is written as the type number. And, furthermore, in this first token packet K15, the address of the first terminal 12a is written as the transmission destination address.

Thus a first token packet K15 of the communication not possible reply type is sent from the third node 14c to the outside. This first token packet K15, after passing through the star coupler 16, is sent to the 18th transmission path D18 that is connected to the first node 14a. This first token packet K15 is sent via that 18th transmission path D18 to the star coupler 62 of the first node 14a. The first token packet K15 is input as the first token packet K16 to the star coupler 62 of the first node 14a. The first token packets K15 and K16 are the same entity.

The first token packet K16 is then sent from the star coupler 62 to the 16th transmission path D16. Then, after passing through that 16th transmission path D16, the first token packet K16 is received by the fixed wavelength filter 56 of the first node 14a (S61 in FIG. 14B). This fixed wavelength filter 56 selects the first token packet K16 of wavelength λ₄ and transmits that first token packet K16 to the second O/E 54 of the first node 14a (S62 in FIG. 14B). That is, the fixed wavelength filter 56 sends the first token packet K16 to the 20th transmission path D20. This first token packet K16 is sent via that 20th transmission path D20 to the second O/E 54 of the first node 14a.

Next, the second O/E 54 of the first node 14a converts the received first token packet K16 to a token packet K17 that is an electrical signal. The second O/E 54 then transmits that token packet K17 to the second token receiver 46 of the first node 14a (S63 in FIG. 14B). That is, the second O/E 54 sends the token packet K17 to the ninth transmission path D9. This token packet K17 is sent via that ninth transmission path D9 to the second token receiver As described in the foregoing, the transmission destination address written in the token packet K17 is the address of the first terminal 12a. For that reason, the second token receiver 46 of the first node 14a reads out the connection information K19 from the received token packet K17. As a result, the second token receiver 46 acquires a type number of 3 and a transmission origination address that is the address of the second terminal 12b. Furthermore, the sequence address written in this token packet K17 is the address of the first terminal 12a. Accordingly, the first node 14a acquires the token K18.

Next, the second token receiver 46 of the first node 14a transmits the token K18 and the connection information K19 to the connection processor 30 of the first node 14a (S64 in FIG. 14C). That is, the second token receiver 46 sends the token K18 and the connection information K19 to the 11th transmission path D11. The token K18 and the connection information K19 are sent via that 11th transmission path D11 to the connection processor 30 of the first node 14a.

Next, the connection processor 30 of the first node 14a extracts the transmission origination address from the received connection information K19. As a result, the connection processor 30 acquires the address of the second terminal 12b. The connection processor 30 also extracts the type number 3 from the received connection information K19. From these pieces of information, the connection processor 30 of the first node 14a learns that communication with the second terminal 12b is not possible.

Next, the connection processor 30 of the first node 14a transmits a transmission not possible signal K20 and a reception not possible signal K21 to the terminal transmitter 22 and the terminal receiver 24, respectively (S65 in FIG. 14C). That is, the connection processor 30 sends the transmission not possible signal K20 to the second transmission path D2, and the reception not possible signal K21 to the fourth transmission path D4. The transmission not possible signal K20 is sent via the second transmission path D2 to the terminal transmitter 22 of the first terminal 12a. And the reception not possible signal K21 is sent via the fourth transmission path D4 to the terminal receiver 24 of the first terminal 12a.

The terminal transmitter 22 of the first terminal 12a has thus received the transmission not possible signal K20, and therefore performs no operations during data transmission. And the terminal receiver 24 of the first terminal 12a, in response to the received reception not possible signal K21, notifies the user of the first terminal 12a that a call cannot be made with the second terminal 12b (S66 in FIG. 14C).

As described in the foregoing, it is possible to implement a wavelength division multiplexing type network system. In the network system of this embodiment, furthermore, a connection establishing channel and data transmission channels are prepared separately. Also, the data transmission channels are different for each node. Accordingly, data can be transmitted and received between nodes that have established connections, irrespective of the acquisition of tokens. Thus data transfer efficiency in the network system is improved.

In the network system in this embodiment, furthermore, data transfers between nodes are conducted by optical signals, wherefore communications can be made high-speed.

[Second Embodiment]

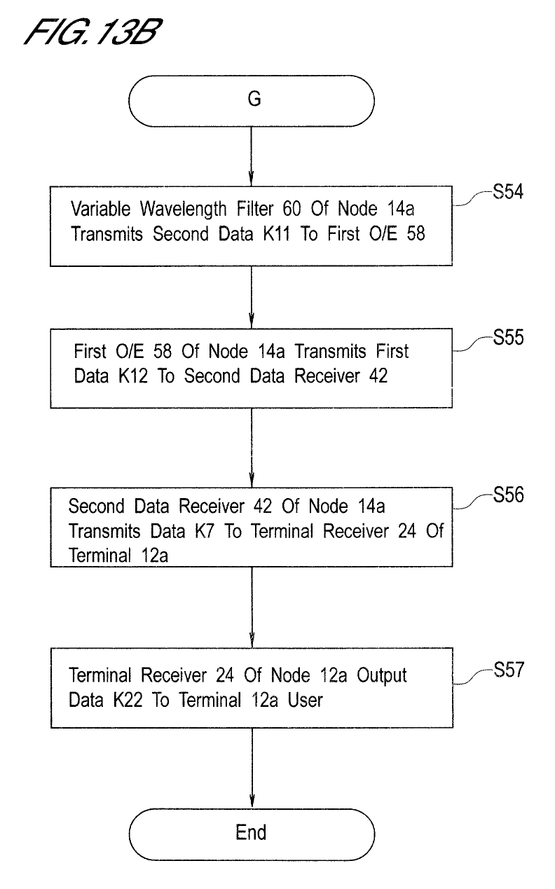

Next, a network system in a second embodiment is described. FIG. 15 is a block diagram of the configuration of the network system in the second embodiment. In FIG. 15, the logical structure is diagrammed as well as the actual physical structure to facilitate understanding the operations of this network system.

The network system 64 in this second embodiment is configured with n terminals 12 and n nodes 66 (where n is an integer 2 or greater), and a star coupler 16. The terminals 12 are each connected individually to each of the nodes 66 by an electrical circuit line Q1. Each of the nodes 66 is also connected by an optical transmission path Q2 to the star coupler 16. The nodes 66 are also connected to each other via the star coupler 16 to configure a communications network 68.

In the network system 64 in the second embodiment, the configuration of the nodes 66 differs from the configuration of the nodes in the network system of the first embodiment. The description which follows focuses on the configuration of the nodes 66.

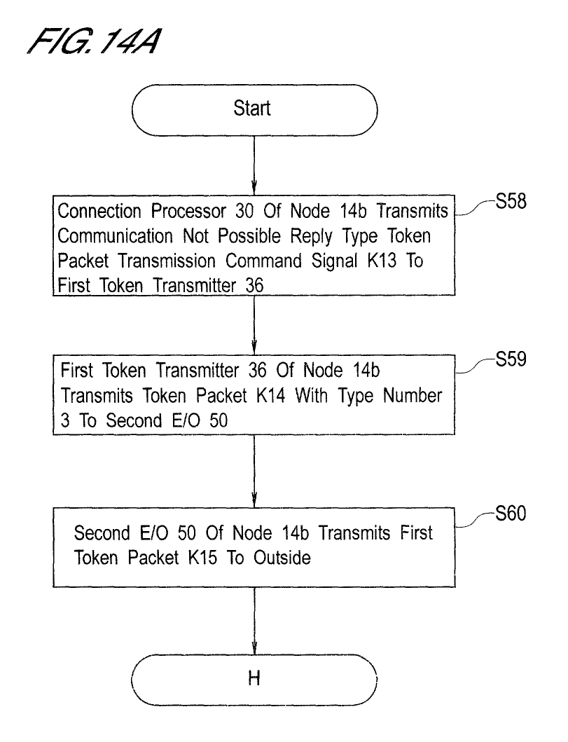

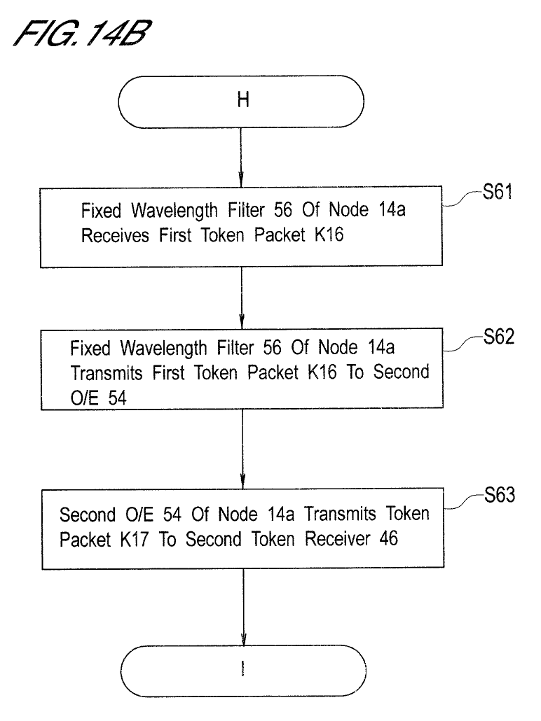

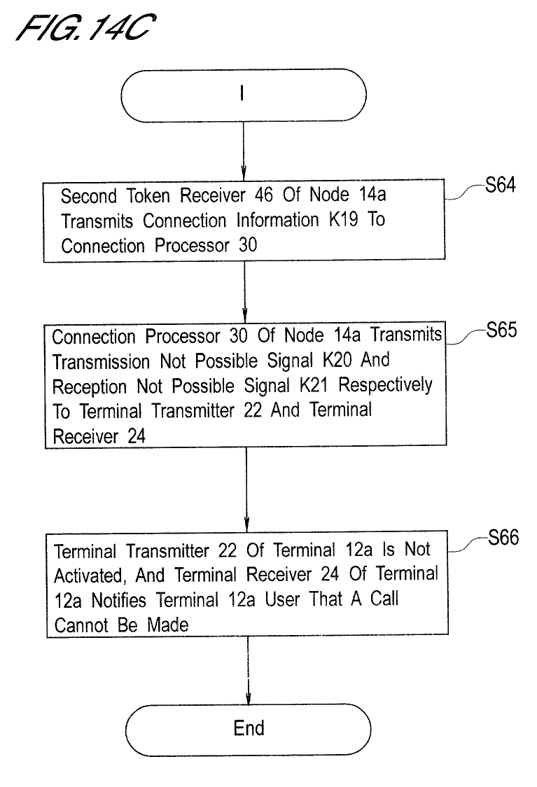

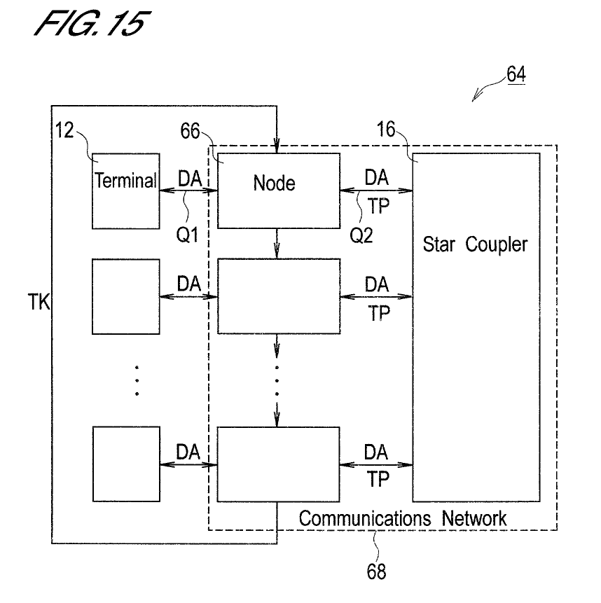

The internal configuration of the node 66 is described with reference to FIG. 16, 17, and 18. FIG. 16 is a block diagram of the internal configuration of a terminal and a node. FIG. 17 is a block diagram of the configuration of a transmitter. And FIG. 18 is a block diagram of the configuration of a receiver.

As diagrammed in FIG. 16, the terminal 12 is configured by a recipient input unit 20, a terminal transmitter 22, and a terminal receiver 24. The node 66 is configured by a transmitter 70, a receiver 72, and a connection processor 30.

As diagrammed in FIG. 17, the transmitter 70 is configured with a first data transmitter 32, a second data transmitter 74, a first token transmitter 36, a second token transmitter 76, and an electrical converging device 78. Of these, the second data transmitter 74 is configured with a first CDMA spreading device 80 and a first electric-to-optical conversion device (hereinafter called E/o) 82 that is a first electric-to-optical conversion device. The second token transmitter 76 is configured with a second CDMA spreading device 84 and the E/O 82 that is a second electric-to-optical conversion device. Thus the second data transmitter 74 and the second token transmitter 76 share the same E/O 82. This E/O 82 is configured by a light source 86 and an intensity modulating device 88.

As diagrammed in FIG. 18, the receiver 72 is configured with a first data receiver 90, a second data receiver 42, a first token receiver 92, a second token receiver 46, and an electrical branching device 94. Of these, the first data receiver 90 is configured by an optical-to-electric conversion device (hereinafter O/E) 96 as a first optical-to-electric conversion device, and a first CDMA reverse spreading device 98. This reverse spreading device is also called a correlator. The first token receiver 92 is configured with an O/E 96 as a second optical-to-electric conversion device, and a second CDMA reverse spreading device 100. Thus the first data receiver 90 and the first token receiver 92 share the same O/E 96.

Next, the connection relations between the components configuring the terminals 12 and nodes 14 are described. In a network system 10, 21st to 41st transmission paths D21 to D41 are provided as connecting circuit lines.

The 21st transmission path D21 connects between the recipient input unit 20 and the connection processor 30. The 22nd transmission path D22 connects between the terminal transmitter 22 and the connection processor 30. The 23rd transmission path D23 connects between the terminal transmitter 22 and the first data transmitter 32. The 24th transmission path D24 connects between the terminal receiver 24 and the connection processor 30. And the 25th transmission path D25 connects between the terminal receiver 24 and the second data receiver 42.

These transmission paths D21 to D25 configure the electrical circuit line Q1 indicated in FIG. 15.

The 26th transmission path D26 connects between the first data transmitter 32 and the first CDMA spreading device 80. The 27th transmission path D27 connects between the first CDMA reverse spreading device 98 and the second data receiver 42. The 28th transmission path D28 connects between the first token receiver 36 and the second CDMA spreading device 84. The 29th transmission path D29 connects between the second CDMA reverse spreading device 100 and the second token receiver 46. The 30th transmission path D30 connects between the connection processor 30 and the first CDMA reverse spreading device 98. The 31st transmission path D31 connects between the connection processor 30 and the second token receiver 46. And the 32nd transmission path D32 connects between the connection processor 30 and the first token transmitter 36.

Because the configuration is made in this way, third data K30 transmitted from the first CDMA spreading device 80 and a second token packet K31 transmitted from the second CDMA spreading device 84 are directed via the electrical converging device 78 to one transmission path D37. This transmission path D37 is connected to the E/O 82 which doubles as the first electric-to-optical conversion device and the second electric-to-optical conversion device.

The 33rd transmission path D33 connects between the intensity modulation device 88 and the star coupler 16 indicated in FIG. 15. And the 34th transmission path D34 connects between the O/E 96 and the star coupler 16 indicated in FIG. 15.

These transmission paths D33 and D34 configure the optical transmission path Q2 indicated in FIG. 15.

The 35th transmission path D35 connects between the first CDMA spreading device 80 and the electrical converging device 78. The 36th transmission path D36 connects between the second CDMA spreading device 84 and the electrical converging device 78. The 37th transmission path D37 connects between the electrical converging device 78 and the intensity modulation device 88. The 38th transmission path D38 connects between the light source 86 and the intensity modulation device 88. The 39th transmission path D39 connects between the O/E 96 and the electrical branching device 94. The 40th transmission path D40 connects between the electrical branching device 94 and the second CDMA reverse spreading device 100. And the 41st transmission path D41 connects between the electrical branching device 94 and the first CDMA reverse spreading device 98.

Because the configuration is made in this way, the second data K11 and first token packet K16 sent from the communications network 68 are input to the O/E 96 that doubles as the first optical-to-electric conversion device and the second optical-to-electric conversion device. Also, the single transmission path D39 connected to that O/E 96 couples the first CDMA reverse spreading device 98 and the second CDMA reverse spreading device 100 through the electrical branching device 94.

The configuration of the terminal 12 described in the foregoing is as was described for the first embodiment and so is not further described here.

Next, the functions of the components configuring the transmitter 70 of the node 66 are described.

The first data transmitter 32, after converting the data K5 received from the terminal 12 to first data K8 in a prescribed format, transmits those first data K8 to the second data transmitter 74. This first data transmitter 32 is the same as that described for the first embodiment.

To this first data transmitter 32 are input, via the 23rd transmission path D23, the data K5 sent from the terminal transmitter 22. Then the first transmitter 32 subjects those input data K5 to primary modulation such as PSK modulation or the like, converting the data K5 to first data K8 (electrical signal). By a prescribed format is meant a data format obtained by such modulation. The first data transmitter 32 then sends the obtained first data K8 to the 26th transmission path D26. These first data K8 are sent via that 26th transmission path D26 to the second data transmitter 74.

The second data transmitter 74, after converting the first data K8 received from the first data transmitter 32 to second data K9 on one of the data transmission channels, transmits these second data K9 to the communications network 68. The n channels are assigned beforehand, as data transmission channels, one by one to each of the nodes 66 without redundancy.

In this embodiment, moreover, the data transmission channels described above are designated by the codes C₁ to Cₙ in code division multiple access. That is, the i'th channel (where i is a natural number from 1 to n) is made the code C₁.

As described earlier, the second data transmitter 74 is configured by the first CDMA spreading device 80 and the E/O 82. This first CDMA spreading device 80 spreads the received first data K8 with one of the codes from C₁ to Cₙ, converting those data K8 to third data K30. The E/O 82 also converts the third data K30 sent from the first CDMA spreading device 80 to second data K9.

To the first CDMA spreading device 80 described above are input the first data K8 sent from the first data transmitter 32, via the 26th transmission path D26. The first CDMA spreading device 80 spreads the input first data K8 with one of the codes C₁ to Cₙ assigned beforehand. That is, the first CDMA spreading device 80 performs code division multiple access. In other words, the input data are subjected to spectrum spreading in the first CDMA spreading device 80. As a result of that spreading, the first data K8 are converted to third data K30. These third data K30 are an electrical signal. The third data K30 obtained by spreading with the code Cᵢ are hereinafter called Cᵢ code third data K30.

The first CDMA spreading device 80 then sends the third data K30 to the 35th transmission path D35. These third data K30 are sent via that 35th transmission path D35 to the electrical converging device 78. These third data K30 are thereupon sent via the electrical converging device 78 to the 37th transmission path D37. These third data K30 are sent via that 37th transmission path D37 to the intensity modulation device 88 of the E/O 82.

In the E/O 82, light generated by the light source 86 is continuously output to the 38th transmission path D38. This light is sent via that 38th transmission path D38 to the intensity modulation device 88. The intensity modulation device 88 modulates the intensity of that light output from the light source 86 according to the third data K30. The intensity modulation device 88 then sends that modulated light as second data K9 to the 33rd transmission path D33. These second data K9 are sent via that 33rd transmission path D33 to the star coupler 16 indicated in FIG. 15.

The first token transmitter 36 is a token transmitter that produces a token packet K14 and transmits that token packet K14 to the second token transmitter 76. This first token transmitter 36 is the same as that described for the first embodiment.

To this first token transmitter 36 is input, via the 32nd transmission path D32, a token packet transmission command signal K13 output from the connection processor 30. The first token transmitter 36, upon receiving the token packet transmission command signal K13, produces the token packet K14, inclusive of connection information and a token, in a prescribed form. The first token transmitter 36 then sends that token packet K14 so produced to the 28th transmission path D28. The token packet K14 is sent via that 28th transmission path D28 to the second token transmitter 76. This token packet K14 is an electrical signal.

The second token transmitter 76 is a transmitter that converts the token packet K14 received from the first token transmitter 36 to a first token packet K15 on the connection establishing channel. The second token transmitter 76 also transmits that first token packet K15 to the communications network 68. The (n+1)th channel that is different from the data transmission channels is used for the connection establishing channel.

In this embodiment, moreover, the (n+1)th channel described earlier is made the code Cₙ₊₁ in code division multiple access. This code Cₙ₊₁ is a code that is different from the codes C₁ to Cₙ described earlier.

As described earlier, the second token transmitter 76 is configured by the second CDMA spreading device 84 and the E/O 82. This second CDMA spreading device 84 spreads the received token packet K14 with the Cₙ₊₁ code, converting that token packet K14 to a second token packet K31. The E/O 82 then converts the second token packet K31 sent from the second CDMA spreading device 84 to a first token packet K15.

To the second CDMA spreading device 84 described above is input, via the 28th transmission path D28, the token packet K14 output from the first token transmitter 36. The second CDMA spreading device 84 spreads the input token packet K14 with the Cₙ₊₁ code. That is, the second CDMA spreading device 84 performs code division multiple access. In other words, the input data are subjected to spectrum spreading in the second CDMA spreading device 84. As a result of this spreading, the token packet K14 is converted to second token packet K31. This second token packet K31 is an electrical signal.

The second CDMA spreading device 84 then sends the second token packet K31 to the 36th transmission path D36. This second token packet K31 is sent via that 36th transmission path D36 to the electrical converging device 78. This second token packet K31 is then sent via the electrical converging device 78 to the 37th transmission path D37. This second token packet K31 is sent via that 37th transmission path D37 to the intensity modulation device 88 of the E/O 82.

In the E/O 82, the intensity modulation device 88 modulates the intensity of the light output from the light source 86 according to the received second token packet K31. The intensity modulation device 88 then transmits the modulated light as a first token packet K15 to the 33rd transmission path D33. This first token packet K15 is sent via that 33rd transmission path D33 to the star coupler 16 indicated in FIG. 15.

Next, the functions of the components configuring the receiver 72 of the node 66 are described.

The first data receiver 90 is a receiver that selects one of the data reception channels and thereby receives the second data K11 from the communications network 68. This first data receiver 90 converts this second data K11 to first data K12. The first data receiver 90 then transmits these first data K12 to the second data receiver 42.

As described in the foregoing, in this embodiment, the codes from C₁ to Cₙ are used for the data reception channels. Also, the first data receiver 90 in this example is configured by an O/E 96 and a first CDMA reverse spreading device 98. The O/E 96 is a device that converts the second data K11 to the third data K32. The first CDMA reverse spreading device 98 subjects the third data K32 sent from the O/E 96 to reverse spreading with one of the codes from C₁ to Cₙ, converting those data to first data K12.

The second data K11 output from the star coupler 16 indicated in FIG. 15 are input via the 34th transmission path D34 to the O/E 96. The O/E 96 converts the input second data K11 to third data K32 that are an electrical signal. The O/E 96 then sends those third data K32 to the 39th transmission path D39. The third data K32 are sent via that 39th transmission path D39 to the electrical branching device 95. The third data K32 are then sent from the electrical branching device 94 to the 41st transmission path D41. The third data K32 are sent via that 41st transmission path D41 to the first CDMA reverse spreading device 98. The third data K32 are also branched to the 40th transmission path D40 side by the electrical branching device 94.

To the first CDMA reverse spreading device 98 described in the foregoing, the third data K32 output from the electrical branching device 94 are input, via the 41st transmission path D41. The configuration is made so that to this first CDMA reverse spreading device 98 is input a transmission origination channel selection signal K10 sent from the connection processor 30, via the 30th transmission path D30. This transmission origination channel selection signal K10 contains the type number 2 or 4 and connection information. This transmission origination channel selection signal K10 also contains the transmission origination address information described earlier. Upon receiving the transmission origination channel selection signal K10, the first CDMA reverse spreading device 98 selects one of the codes from C₁ to Cₙ based on the transmission origination channel contained therein. That is, the first CDMA reverse spreading device 98 selects the data transmission channel assigned to the node 66 that is the transmission originator for the third data K32.

The first CDMA reverse spreading device 98 then subjects the third data K32 input via the 41st transmission path D41 to reverse spreading with the selected code. That is, the input data are subjected to spectrum reverse spreading in the first CDMA reverse spreading device 98. As a result of this reverse spreading, the third data K32 are converted to first data K12. These first data K12 are an electrical signal.

Thus the first CDMA reverse spreading device 98 receives only the third data K32 of the selected code. Accordingly, the first CDMA reverse spreading device 98 is capable of selectively receiving the third data K32 on the desired channel from the data on the plurality of channels input via the 41st transmission path D41.

The first data K12 obtained with the first CDMA reverse spreading device 98 are sent to the 27th transmission path D27. These first data K12 are sent to the second data receiver 42 via that 27th transmission path D27.

The second data receiver 42 converts the first data K12 received from the first data receiver 90, that is, from the first CDMA reverse spreading device 98, to data K7 and transmits these data K7 to the terminal 12. The format of these data K7 is made to be a data format that can be received by the terminal receiver 24. The data K7 are transmitted via the 25th transmission path D25 to the terminal receiver 24. This second data receiver 42 is the same as that described in the first embodiment.

The first token receiver 92 is a receiver that receives the first token packet K16 from the communications network 68 using the (n+1)th channel. The first token receiver 92 converts that first token packet K16 to the token packet K17. The first token receiver 92 then transmits that token packet K17 to the second token receiver 46.

As described earlier, in this embodiment, the code Cₙ₊₁ is used as the (n+1)th channel. The first token receiver 92 in this example is configured by the O/E 96 and the second CDMA reverse spreading device 100. The O/E 96 is a device for converting the received first token packet K16 to the second token packet K33. The second CDMA reverse spreading device 100 is a device that subjects the second token packet K33 sent by the O/E 96 to reverse spreading with the Cₙ₊₁ code, converting that token packet K33 to the token packet K17.

The first token packet K16 output from the star coupler 16 indicated in FIG. 15 is input to the O/E 96 via the 34th transmission path D34. The O/E 96 converts the input first token packet K16 to a second token packet K33 that is an electrical signal. The O/E 96 then sends the second token packet K33 to the 39th transmission path D39. The second token packet K33 is sent via that 39th transmission path D39 to the electrical branching device 94. The second token packet K33 is then sent from the electrical branching device 94 to the 40th transmission path D40. The second token packet K33 is sent via that 40th transmission path D40 to the second CDMA reverse spreading device 100. The second token packet K33 is also branched to the 41st transmission path D41 side by the electrical branching device 94.

To the second CDMA reverse spreading device 100 described in the foregoing is input the second token packet K33 output from the electrical branching device 94, via the 40th transmission path D40. This second CDMA reverse spreading device 100 subjects the input second token packet K33 to reverse spreading with the code Cₙ₊₁. That is, the input data are subjected to spectrum reverse spreading in the second CDMA reverse spreading device 100. As a result of this reverse spreading, the second token packet K33 is converted to a token packet K17. This token packet K17 is an electrical signal.

Thus the second CDMA reverse spreading device 100 receives only Cₙ₊₁ code data. Accordingly, the second CDMA reverse spreading device 100 is capable of selectively receiving the second token packet K33 on the desired channel from among data on a plurality of channels input via the 40th transmission path D40.

The token packet K17 obtained by the second CDMA reverse spreading device 100 is sent to the 29th transmission path D29. The token packet K17 is sent via that 29th transmission path D29 to the second token receiver 46.

The second token receiver 46 extracts a token and the connection information relating to that second token receiver 46 from the token packet K17 received from the first token receiver 92, that is, from the second CDMA reverse spreading device 100. The second token receiver 46 then sends the extracted token and connection information to the connection processor 30. This second token receiver 46 is the same as that described in the first embodiment.

The second token receiver 46 verifies the transmission destination address contained in the received token packet K17. Let it be assumed that this transmission destination address is the address of the node 66 having that second token receiver 46. Thereupon, the second token receiver 46 extracts the transmission origination address and type number contained in that token packet K17 as the connection information K19. The second token receiver 46 then sends that extracted connection information K19 to the 31st transmission path D31. The connection information K19 is sent via that 31st transmission path D31 to the connection processor 30.

The second token receiver 46 also sends the sequence address contained in the received token packet K17 to the 31st transmission path D31 as the token K18. This token K18 is sent via that 31st transmission path D31 to the connection processor 30.

The connection processor 30 is substantially the same as that which was described in the first embodiment. That is, the connection processor 30, upon receiving a data transmission request from the terminal 12 connected to that connection processor 30, causes the first token transmitter 36 to produce prescribed connection information. This connection processor 30, when it has received the token K18 and the connection information K19 from the second token receiver 46, in cases where it is possible to establish a connection, causes the first data receiver 90 connected to that connection processor 30, that is, the first CDMA reverse spreading device 98, to select the data transmission channel assigned to the data transmission originating node 66.

To this connection processor 30 is input the recipient number signal K2 output from the recipient input unit 20 of the terminal 12. The connection processor 30, by receiving the recipient number signal K2, accepts the data transmission request from the terminal 12. The connection processor 30 then sends a communication request type token packet transmission command signal K13 to the 32nd transmission path D32. This token packet transmission command signal K13 contains the recipient number signal K2. This token packet transmission command signal K13 is sent via the 32nd transmission path D32 to the first token transmitter 36. As described earlier, the first token transmitter 36 produces the token packet K14, which contains connection information and a token, according to the token packet transmission command signal K13.

To the connection processor 30 is input, via the 31st transmission path D31, the token K18 or the connection information K19 sent from the second token receiver 46. The connection processor 30 performs one of the processing routines 1 to 4 described in the first embodiment, according to the type number in the received connection information.

As was described earlier, it is thus possible to implement a code division multiple access type network system. In the network system in this embodiment, a connection establishing channel and data transmission channels are provided separately. These data transmission channels are also different for each node. Accordingly, data can be transmitted and received between nodes for which a connection has been established, irrespective of token acquisition. Thus data transfer efficiency is improved in the network system.

In the network system in this embodiment, moreover, a common E/O 82 is used as the first and the second electric-to-optical conversion devices. Accordingly, the number of components can be reduced, and the nodes 66 can be made smaller and at lower cost.

Similarly, in the network system in this embodiment, a common O/E 96 is used as the first and second optical-to-electric conversion devices. Accordingly, the number of components can be reduced, and the nodes 66 can be made smaller and at lower cost.

In the network system of this embodiment, furthermore, data transfers between nodes are conducted by optical signals, wherefore communications can be effected at higher speeds.

[Third Embodiment]

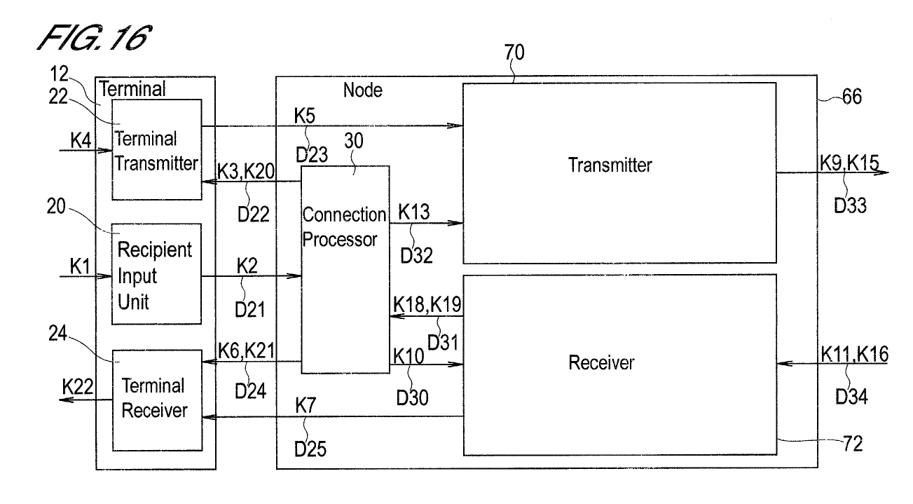

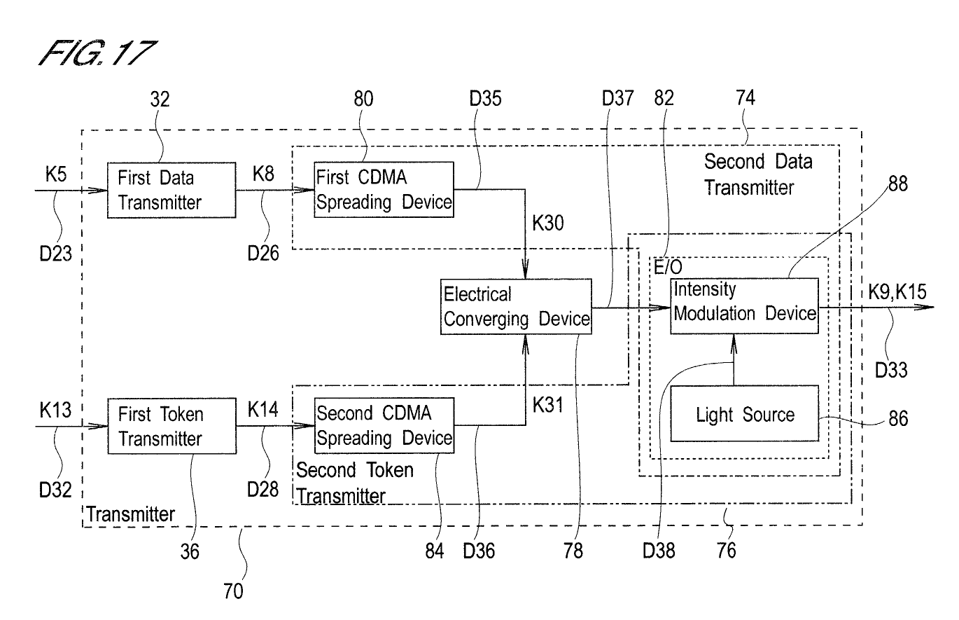

A network system in a third embodiment is next described. FIG. 19 is a block diagram of the configuration of the network system in the third embodiment. In FIG. 19, the logical structure is diagrammed as well as the actual physical structure to facilitate understanding the operations of this network system.

The network system 102 in this third embodiment is configured with n terminals 12 and n nodes 104 (where n is an integer 2 or greater), and a star coupler 16. The terminals 12 are each connected individually to each of the nodes 104 by an electrical circuit line Q1. Each of the nodes 104 is also connected by an optical transmission path Q2 to the star coupler 16. The nodes 104 are also connected to each other via the star coupler 16 to configure a communications network 106.

In the network system 102 in the third embodiment, the configuration of the nodes 104 differs from the configuration of the nodes in the network system of the first embodiment. The following description focuses on the configuration of the nodes 104.

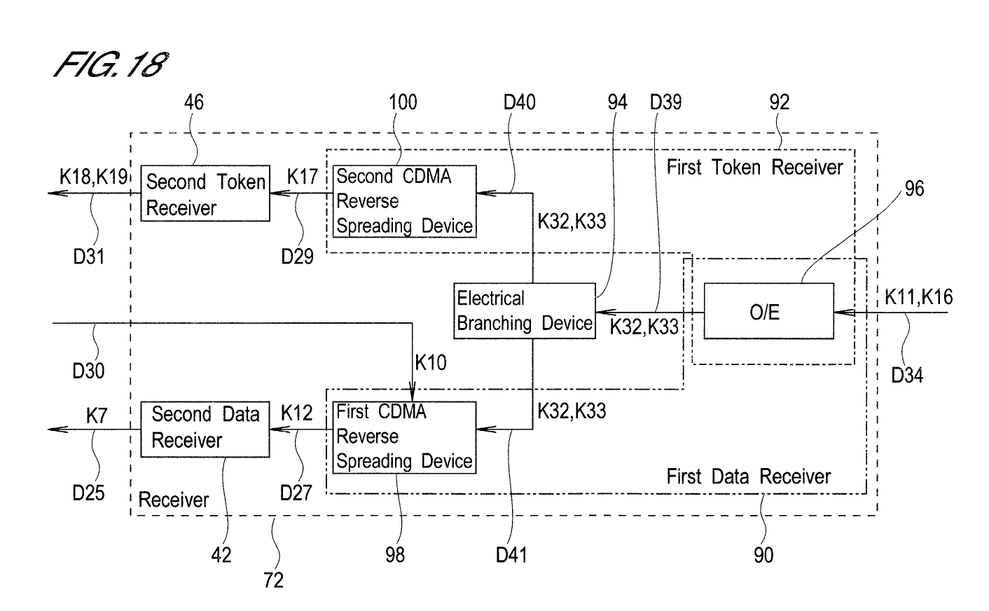

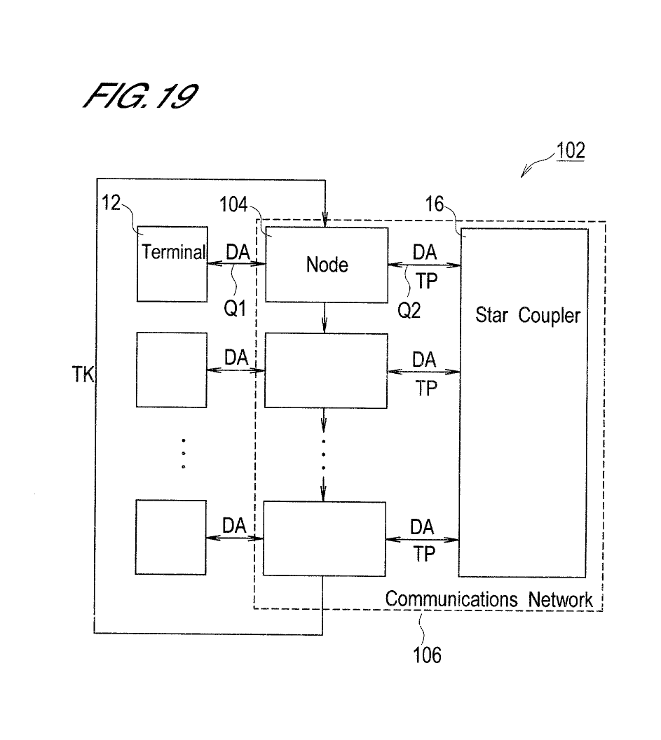

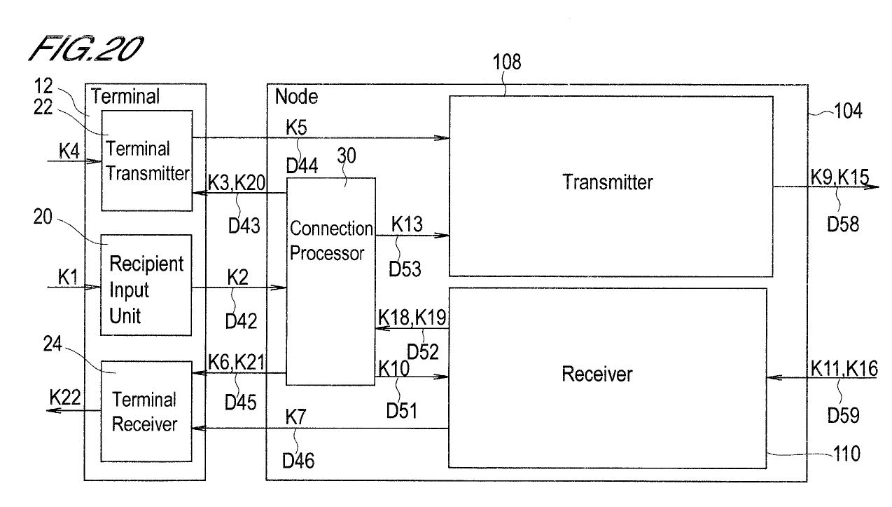

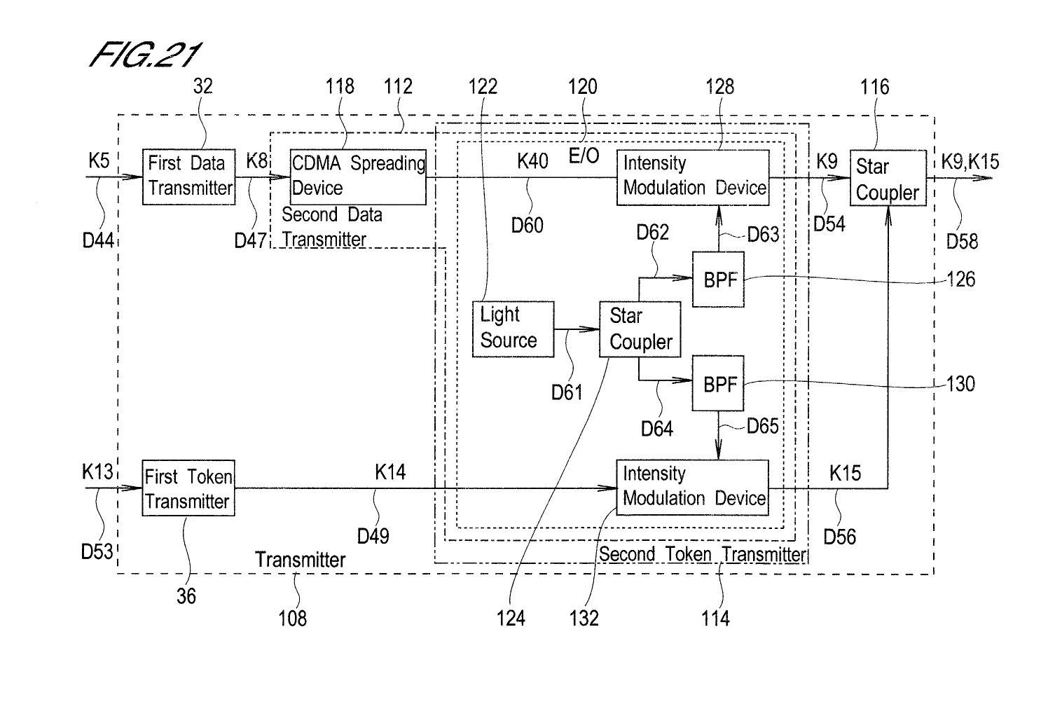

The internal configuration of the node 104 is now described with reference to FIG. 20, 21, and 22. FIG. 20 is a block diagram of the internal configuration of a terminal and a node. FIG. 21 is a block diagram of the configuration of a transmitter. And FIG. 22 is a block diagram of the configuration of a receiver.

As diagrammed in FIG. 20, the terminal 12 is configured by a recipient input unit 20, a terminal transmitter 22, and a terminal receiver 24. The node 104 is configured by a transmitter 108, a receiver 110, and a connection processor 30.

As diagrammed in FIG. 21, moreover, the transmitter 108 is configured with a first data transmitter 32, a second data transmitter 112, a first token transmitter 36, a second token transmitter 114, and a star coupler 116. Of these, the second data transmitter 112 is configured with a CDMA spreading device 118 and an electric-to-optical conversion device (hereinafter called E/O) 120 as a first electric-to-optical conversion device. The second token transmitter 114 is configured by an E/O 120 as a second electric-to-optical conversion device. The E/O 120 is configured by a light source 122, a star coupler 124, band pass filters (hereinafter BPFs) 126 and 130, and intensity modulation devices 128 and 132. The second data transmitter 112 and the second token transmitter 114 have the light source 122 in common.

As diagrammed in FIG. 22, moreover, the receiver 110 is configured with a first data receiver 134, a second data receiver 42, a first token receiver 136, a second token receiver 46, and a star coupler 138. Of these, the first data receiver 134 is configured with a variable wavelength filter 140, a first optical-to-electric conversion device (hereinafter called the first O/E) 142, and a CDMA reverse spreading device 144. The first token receiver 136 is configured with a fixed wavelength filter 146 and a second optical-to-electric conversion device (hereinafter called the second O/E) 148.

The connection relationships between the components configuring the terminals 12 and nodes 14 are described next. In the network system 102 are provided a 42nd to a 68th transmission path D42 to D68 as connection circuit lines.

The 42nd transmission path D42 connects between the recipient input unit 20 and the connection processor 30. The 43rd transmission path D43 connects between the terminal transmitter 22 and the connection processor 30. The 44th transmission path D44 connects between the terminal transmitter 22 and the first data transmitter 32. The 45th transmission path D45 connects between the terminal receiver 24 and the connection processor 30. And the 46th transmission path D46 connects between the terminal receiver 24 and the second data receiver 42.

These transmission paths D42 to D46 configure the electrical circuit line Q1 diagrammed in FIG. 19.

The 47th transmission path D47 connects between the first data transmitter 32 and the CDMA spreading device 118. The 48th transmission path D48 connects between the CDMA reverse spreading device 144 and the second data receiver 42. The 49th transmission path D49 connects between the first token transmitter 36 and the intensity modulation device 132. The 50th transmission path D50 connects between the second O/E 148 and the second token receiver 46. The 51st transmission path D51 connects between the connection processor 30 and the CDMA reverse spreading device 144, and between the connection processor 30 and the variable wavelength filter 140. The 52nd transmission path D52 connects between the connection processor 30 and the second token receiver 46. The 53rd transmission path D53 connects between the connection processor 30 and the first token transmitter 36. The 54th transmission path D54 connects between the intensity modulation device 128 and the star coupler 116. The 55th transmission path D55 connects between the variable wavelength filter 140 and the star coupler 138. The 56th transmission path D56 connects between the intensity modulation device 132 and the star coupler 116. And the 57th transmission path D57 connects between the fixed wavelength filter 146 and the star coupler 138.

The 58th transmission path D58 connects between the star coupler 116 and the star coupler 16 indicated in FIG. 19. And the 59th transmission path D59 connects between the star coupler 138 and the star coupler 16 indicated in FIG. 19.

These transmission paths D58 and D59 configure the optical transmission path Q2 indicated in FIG. 19.

The 60th transmission path D60 connects between the CDMA spreading device 118 and the intensity modulation device 128. The 61st transmission path D61 connects between the light source 122 and the star coupler 124. The 62nd transmission path D62 connects between the star coupler 124 and the BPF 126. The 63rd transmission path D63 connects between the BPF 126 and the intensity modulation device 128. The 64th transmission path D64 connects between the star coupler 124 and the BPF 130. And the 65th transmission path D65 connects between the BPF 130 and the intensity modulation device 132.

The 66th transmission path D66 connects between the variable wavelength filter 140 and the first O/E 142. The 67th transmission path D67 connects between the first O/E 142 and the CDMA reverse spreading device 144. And the 68th transmission path D68 connects between the fixed wavelength filter 146 and the second O/E 148.

The configuration of the terminal 12 described earlier is the same as was described in the first embodiment and so is not further described here.

The functions of the components configuring the transmitter 108 of the node 104 are described next.

The first data transmitter 32, after converting data K5 received from the terminal 12 to first data K8 in a prescribed format, transmits those first data K8 to the second data transmitter 112. This first data transmitter 32 is the same as that described in the first embodiment.

To this first data transmitter 32 are input the data K5 output from the terminal transmitter 22, via the 44th transmission path D44. The first data transmitter 32 then subjects the input data K5 to primary modulation such as PSK modulation, converting those data K5 to the first data K8 (electrical signal). By a prescribed format is meant a data format obtained by such modulation. The first data transmitter 32 then sends the obtained first data K8 to the 47th transmission path D47. These first data K8 are sent via that 47th transmission path D47 to the second data transmitter 112.

The second data transmitter 112 is a transmitter that, after converting the first data K8 received from the first data transmitter 32 to second data K9 on one of the data transmission channels, transmits those second data K9 to the communications network 106. The data transmission channels are configured such that one of n channels is assigned to each node 104 so that there is no redundancy.

In this embodiment, furthermore, it is assumed that n=n(p, q)=p×q (where p and q are natural numbers). The data transmission channels noted earlier are made to be combinations (λᵢ, Cⱼ) of a light wavelength λᵢ (where i is a natural number from 1 to p) and a code Cⱼ (where j is a natural number from 1 to q) in code division multiple access.

Let it be assumed, for example, that n=3 and that (p, q)=(1, 3). Thereupon, the combination (λ₁, C₁) is used for the 1st channel, the combination (λ₁, C₂) for the 2nd channel, and the combination (λ₁, C₃) for the 3rd channel.

As has already been described, furthermore, an (n+1)th channel that differs from the data transmission channels is used as a connection establishing channel. In this embodiment, the (n+1)th channel noted above is given the light wavelength λₚ₊₁. This wavelength λₚ₊₁ is a wavelength that differs from the wavelengths from λ₁ to λₚ noted above.

As described earlier, moreover, the second data transmitter 112 is configured by the CDMA spreading device 118 and the E/O 120. This CDMA spreading device 118 is a device that spreads received first data K8 with one of the codes from C₁ to C_{q}, converting those data to third data K40. The E/O 120, meanwhile, is a device for converting the third data K40 sent from the CDMA spreading device 118 to second data K9 having one of the wavelengths from λ₁ to λₚ.

To the CDMA spreading device 118 described above are input the first data K8 sent from the first data transmitter 32, via the 47th transmission path D47. The CDMA spreading device 118 spreads the input first data K8 with one of the codes C₁ to C_{q} assigned beforehand. That is, the CDMA spreading device 118 performs code division multiple access. In other words, input data are subjected to spectrum spreading in the CDMA spreading device 118. As a result of this spreading, the first data K8 are converted to the third data K40. These third data K40 are an electrical signal. The third data K40 obtained by spreading with the code Cⱼ are hereinafter called Cⱼ code third data K40.

The CDMA spreading device 118 then sends the third data K40 to the 60th transmission path D60. These third data K40 are sent via that 60th transmission path D60 to the intensity modulation device 128 of the E/O 120.

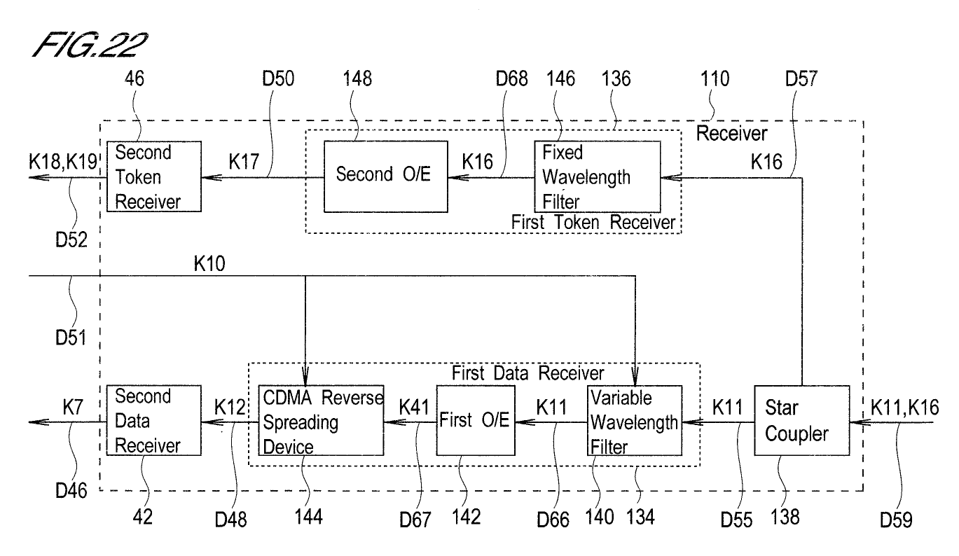

In the E/O 120, light generated by the light source 122 is continuously output to the 61st transmission path D61. The light output from the light source 122 is light having a comparatively broad band. FIG. 23 is a graph representing the spectrum intensities of the light output from the light source 122. The spectrum intensity is plotted on the vertical axis. The light wavelength is plotted on the horizontal axis. As plotted in FIG. 23, the spectrum regions of this light are divided into p+1 regions designated W₁ to Wₚ₊₁. In the regions from W₁ to Wₚ₊₁ are contained the wavelengths from λ₁ to λₚ₊₁, respectively. The region Wₚ₊₁ is assigned to token packet use, while the other regions W₁ to Wₚ are assigned for data use.

The light output from the light source 122 is sent via the 61st transmission path D61 to the star coupler 124. This light is distributed by the star coupler 124 so that it is sent out on both the 62nd transmission path D62 and the 64th transmission path D64. The light sent out on the 62nd transmission path D62 is sent to the one BPF 126, while the light sent out on the 64th transmission path D64 is sent to the other BPF 130.

The transmitting band of the BPF 126 described above is predetermined. More specifically, of the regions from W₁ to Wₚ, one of the regions determined for each of the nodes 104 is established as the transmitting region of the BPF 126. Accordingly, the BPF 126 causes that light of the input wavelengths λ₁ to λₚ that is light of a wavelength contained in the region established as the transmitting band to be selectively transmitted. The light output from the BPF 126 is sent to the 63rd transmission path D63. This light is sent via that 63rd transmission path D63 to the intensity modulation device 128.

Meanwhile, the transmitting band of the BPF 130 noted earlier is also predetermined. Specifically, the region Wₚ₊₁ is established as the transmitting band. Accordingly, the BPF 130 causes the input light of the wavelength λₚ₊₁ to be selectively transmitted. The light output from the BPF 130 is sent to the 65th transmission path D65. This light is sent via that 65th transmission path D65 to the intensity modulation device 132.

The intensity modulation device 128 described earlier modulates the intensity of the light sent from the BPF 126 according to the third data K40 received from the CDMA spreading device 118. The intensity modulation device 128 then transmits that modulated light as second data K9 to the 54th transmission path D54. If the code used by the CDMA spreading device 118 is made Cⱼ, and the wavelength of the light transmitted by the BPF 126 is made λᵢ, then the second data K9 on the (λᵢ, Cⱼ) channel will be output from the intensity modulation device 128. These second data K9 are sent via the 54th transmission path D54 to the star coupler 116. These second data K9 are then sent from the star coupler 116 to the 58th transmission path D58. These second data K9 are sent via that 58th transmission path D58 to the star coupler 16 indicated in FIG. 19.

The first token transmitter 36 is a transmitter that produces a token packet K14 and sends that token packet K14 to the second token transmitter 114. This first token transmitter 36 is the same as that described in the first embodiment.

To this first token transmitter 36 is input a token packet transmission command signal K13 output from the connection processor 30, via the 53rd transmission path D53. The first token transmitter 36, upon receiving the token packet transmission command signal K13, produces a token packet K14, in a prescribed form, containing connection information and a token. The first token transmitter 36 then sends that token packet K14 so produced to the 49th transmission path D49. The token packet K14 is sent via that 49th transmission path D49 to the second token transmitter 114. This token packet K14 is an electrical signal.

The second token transmitter 114 converts the token packet K14 received from the first token transmitter 36 to a first token packet K15 on the connection establishing channel. The second token transmitter 114 then sends this first token packet K15 to the communications network 106. For the connection establishing channel, the (n+1)th channel that differs from the data transmission channels is used.

As already described, in this embodiment, the (n+1)th channel noted above is made to be the light wavelength λₚ₊₁. And, as described in the foregoing, the second token transmitter 114 is configured by the E/O 120. This E/O 120 is a device that converts the received token packet K14 to the first token packet K15 having a wavelength of λₚ₊₁. The token packet K14 sent from the first token transmitter 36 is input to the intensity modulation device 132 of the E/O 120. This intensity modulation device 132 modulates the intensity of the light sent from the BPF 130 according to the token packet K14 received from the first token transmitter 36. The intensity modulation device 132 then transmits the modulated light as the first token packet K15 to the 56th transmission path D56. This first token packet K15 is sent via that 56th transmission path D56 to the star coupler 116. The first token packet K15 is then sent from the star coupler 116 to the 58th transmission path D58. This first token packet K15 is sent via that 58th transmission path to the star coupler 16 indicated in FIG. 19.

Next, the functions of the components configuring the receiver 110 of the node 104 are described.

The first data receiver 134 is a receiver that selects one of the data transmission channels, and thereby receives second data K11 from the communications network 106. This first data receiver 134 converts these second data K11 to first data K12. The first data receiver 134 then transmits these first data K12 to the second data receiver 42.

As described earlier, in this embodiment, the (λᵢ, Cⱼ) channels are used as the data transmission channels. The first data receiver 134 in this example, moreover, is configured by a variable wavelength filter 140, a first O/E 142, and a CDMA reverse spreading device 144. The variable wavelength filter 140 is a device that selects one of the wavelengths from λ₁ to λₚ and thereby receives the second data K11 from the communications network 106. The first O/E 142 is a device that converts the second data K11 sent from the variable wavelength filter 140 to third data K41. The CDMA reverse spreading device 144 subjects the third data K41 sent from the first O/E 142 to reverse spreading with one of the codes from C₁ to C_{q}, converting those data to first data K12.

The second data K11 output from the star coupler 16 indicated in FIG. 19 are sent via the 59th transmission path D59 to the star coupler 138. These second data K11 are sent from the star coupler 138 to the 55th transmission path D55. The second data K11 are sent then via that 55th transmission path D55 to the variable wavelength filter 140.

Thus the second data K11 are input to the variable wavelength filter 140. The configuration is made so that a transmission origination channel selection signal K10 sent from the connection processor 30 is input to the variable wavelength filter 140 via the 51st transmission path D51. This transmission origination channel selection signal K10 contains the type number 2 or 4 and connection information. The transmission origination address information described earlier is also contained in this transmission origination channel selection signal K10. The variable wavelength filter 140, upon receiving the transmission origination channel selection signal K10, selects one of the wavelengths from λ₁ to λₚ based on the transmission origination channel contained therein. That is, the variable wavelength filter 140 selects a wavelength that defines the data transmission channel assigned to the transmission originating node 104 for the second data K11.

Let it be assumed, for example, that the data transmission channel assigned to the transmission originating node 104 for the second data K11 is (λ₁, Cⱼ). Thereupon, the variable wavelength filter 140 selects the wavelength λᵢ.

The variable wavelength filter 140 then causes the second data K11 of the selected wavelength to be transmitted. The second data K11 output from the variable wavelength filter 140 is sent to the 66th transmission path D66.

The second data K11 is sent via the 66th transmission path D66 to the first O/E 142. The first O/E 142 converts the second data K11 so sent to third data K41 that are an electrical signal. The first O/E 142 then sends those third data K41 to the 67th transmission path D67.

To the CDMA reverse spreading device 144 described earlier are input the third data K41 output from the first O/E 142, via the 67th transmission path D67. The configuration is made such that the transmission origination channel selection signal K10 sent from the connection processor 30 is input via the 51st transmission path D51 to that CDMA reverse spreading device 144. This transmission origination channel selection signal K10 contains the type number 2 or 4 and connection information. This transmission origination channel selection signal K10 also contains the transmission origination address information described earlier. The CDMA reverse spreading device 144, upon receiving the transmission origination channel selection signal K10, selects a code that is one of the codes from C₁ to C_{q}, based on the transmission origination channel contained therein. That is, the CDMA reverse spreading device 144 selects the data transmission channel assigned to the transmission originating node 104 for the third data K41.

Let it be assumed, for example, that the data transmission channel assigned to the transmission originating node 104 for the third data K41 is (λᵢ, Cⱼ). When that is the case, the CDMA reverse spreading device 144 selects the code Cⱼ.

The CDMA reverse spreading device 144 then subjects the third data K41 input via the 67th transmission path D67 to reverse spreading with the selected code. That is, in the CDMA reverse spreading device 144, the input data are subjected to spectrum reverse spreading. As a result of this reverse spreading, the third data K41 are converted to first data K12. These first data K12 are an electrical signal.

Thus the CDMA reverse spreading device 144 receives only the third data K41 of the selected code. Accordingly, the CDMA reverse spreading device 144 is capable of selectively receiving third data K41 on the desired channel from the data on the plurality of channels input via the 67th transmission path D67.

The first data K12 obtained by the CDMA reverse spreading device 144 are sent to the 48th transmission path D48. These first data K12 are sent via that 48th transmission path D48 to the second data receiver 42.

The second data receiver 42 is a receiver that converts the first data K12 received from the first data receiver 134, that is, from the CDMA reverse spreading device 144, to data K7 and transmits those data K7 to the terminal 12. The format of these data K7 is made to be a data format capable of being received by the terminal receiver 24. The data K7 are transmitted via the 46th transmission path D46 to the terminal receiver 24. This second data receiver 42 is the same as that described in the first embodiment.

The first token receiver 136 is a receiver that receives the first token packet K16 from the communications network 106 using the (n+1)th channel. The first token receiver 136 converts that first token packet K16 to the token packet K17. The first token receiver 136 then transmits that token packet K17 to the second token receiver 46.

As described in the foregoing, in this embodiment, the wavelength λₚ₊₁ is used for the (n+1)th channel. The first token receiver 136 in this example, moreover, is configured by the fixed wavelength filter 146 and the second O/E 148. The fixed wavelength filter 146 is a device that receives the first token packet K16 having the wavelength λₚ₊₁ from the communications network 106. The second O/E 148 is a device that converts the first token packet K16 sent from the fixed wavelength filter 146 to the token packet K17.

The first token packet K16 output from the star coupler 16 indicated in FIG. 19 is input via the 59th transmission path D59 to the star coupler 138. The first token packet K16 is then sent from the star coupler 138 to the 57th transmission path D57. This first token packet K16 is sent via the 57th transmission path D57 to the fixed wavelength filter 146.

The fixed wavelength filter 146 causes light of wavelength λₚ₊₁ to be transmitted. Accordingly, the fixed wavelength filter 146 selectively receives the input first token packet K16. The first token packet K16 output from the fixed wavelength filter 146 is sent to the 68th transmission path D68. The first token packet K16 is sent via that 68th transmission path D68 to the second O/E 148.

The second O/E 148 converts the input first token packet K16 to the token packet K17 that is an electrical signal. The second O/E 148 then sends that token packet K17 to the 50th transmission path D50. The token packet K17 is sent via that 50th transmission path D50 to the second token receiver 46.

The second token receiver 46 is a receiver that extracts a token and the connection information relating to that second token receiver 46 from the token packet K17 received from the first token receiver 136, that is, from the second O/E 148. The second token receiver 46 then transmits the extracted token and connection information to the connection processor 30. This second token receiver 46 is the same as that described in the first embodiment.

The second token receiver 46 verifies the transmission destination address contained in the received token packet K17. Let it be assumed that that transmission destination address is the address of the node 104 having this second token receiver 46. When that is the case, the second token receiver 46 extracts the transmission origination address and type number contained in this token packet K17 as the connection information K19. The second token receiver 46 then sends the extracted connection information K19 to the 52nd transmission path D52. The connection information K19 is sent via that 52nd transmission path D52 to the connection processor 30.

The second token receiver 46 also sends the sequence address contained in the received token packet K17 to the 52nd transmission path D52 as the token K18. The token K18 is sent via that 52nd transmission path D52 to the connection processor 30.

This connection processor 30 is substantially the same as that which was described in the first embodiment. That is, this connection processor 30, upon receiving a data transmission request from the terminal 12 connected to that connection processor 30, causes the first token transmitter 36 to produce prescribed connection information. This connection processor 30, when it has received the token K18 and connection information K19 from the second token receiver 46 and it is possible to establish a connection, causes the first data receiver 134 connected to that connection processor 30, that is, causes the CDMA reverse spreading device 144 and the variable wavelength filter 140, to select the data transmission channel assigned to the data transmission originating node 104.

To this connection processor 30 is input the recipient number signal K2 sent from the recipient input unit 20 of the terminal 12, via the 42nd transmission path D42. The connection processor 30, by receiving the recipient number signal K2, accepts a data transmission request from the terminal 12. The connection processor 30 then sends a communication request type token packet transmission command signal K13 to the 53rd transmission path D53. This token packet transmission command signal K13 contains the recipient number signal K2. This token packet transmission command signal K13 is sent via the 53rd transmission path D53 to the first token transmitter 36. As described earlier, the first token transmitter 36 produces the token packet K14 containing connection information and a token, according to the token packet transmission command signal K13.

To the connection processor 30 is also input either the token K18 or the connection information K19 sent from the second token receiver 46, via the 52nd transmission path D52. The connection processor 30 performs one of the processing routines 1 to 4 described in the first embodiment, according to the received connection information K19 and the type number.

As described in the foregoing, it is possible to implement a multiplexing type network system that combines wavelength division multiplexing and code division multiple access. In the network system of this embodiment, the connection establishing channel and the data transmission channels are provided separately. Also, the data transmission channels are different for each node. Accordingly, data can be transmitted and received between nodes which have established a connection irrespective of the acquisition of a token. Thus data transfer efficiency in the network system can be improved.

In the network system in this embodiment, furthermore, data transfers between nodes are conducted by optical signals, wherefore communications can be made high-speed.

[Fourth Embodiment]

In the second embodiment, a description was given of a signal propagation method that combines CDMA spreading, CDMA reverse spreading, electric-to-optical conversion, and optical-to-electric conversion. Such a signal propagation method as this can also be applied to network systems other than those which circulate tokens. One example thereof is now described in this fourth embodiment.

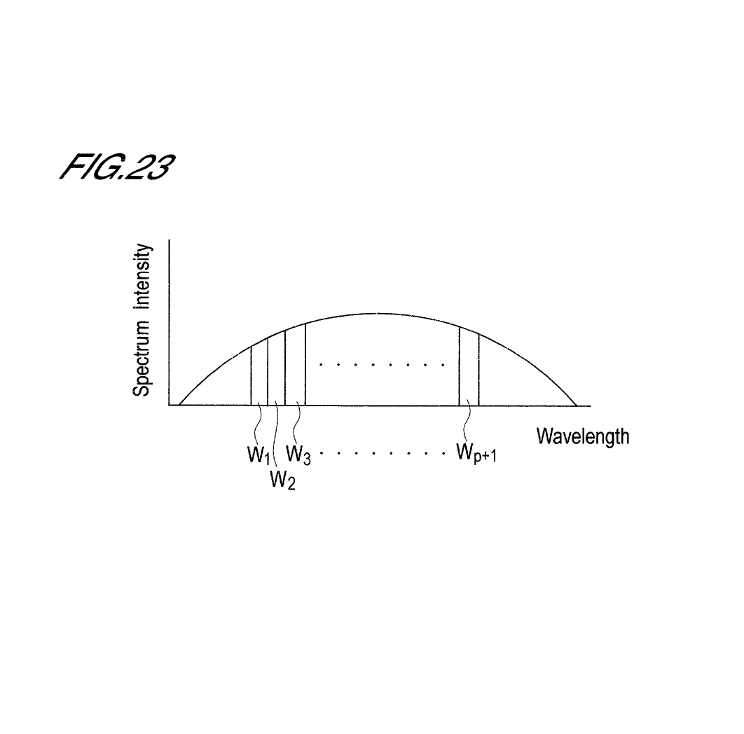

FIG. 24 is a block diagram of the configuration of the network system in the fourth embodiment.

The network system in the fourth embodiment is configured with n terminals 152 and n nodes 154 (where n is an integer 2 or greater), and a star coupler 156. Each of the terminals 152 is connected individually to each of the nodes 154 by an electrical circuit line Q1 for transmitting data DA. Each of the nodes 154 is also connected to the star coupler 156 by an optical transmission line Q2 for transmitting data DA. The nodes 154 are also each interconnected by the star coupler 156 to configure an optical communications network 158.

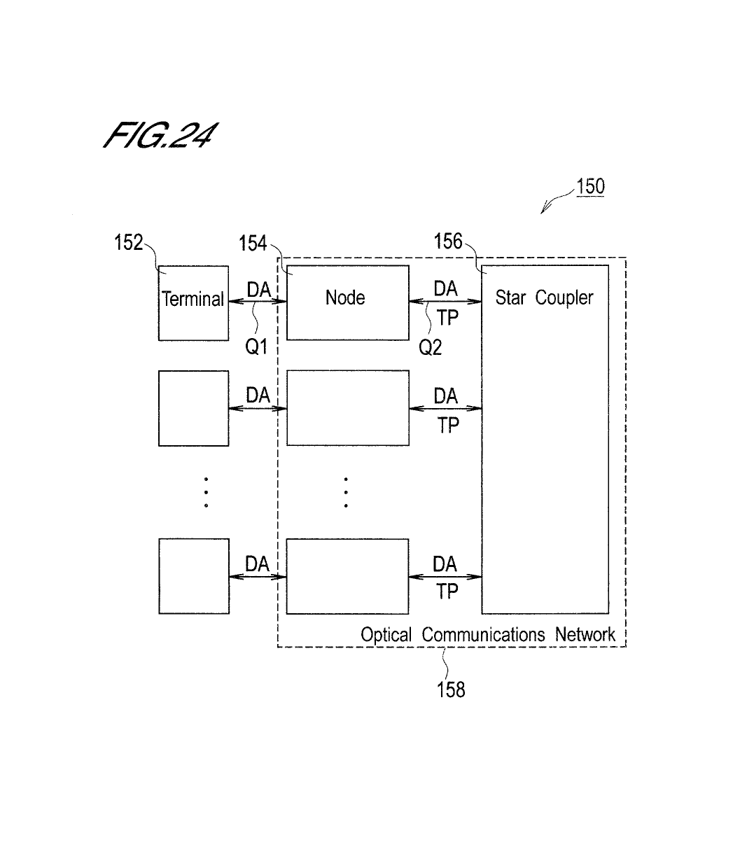

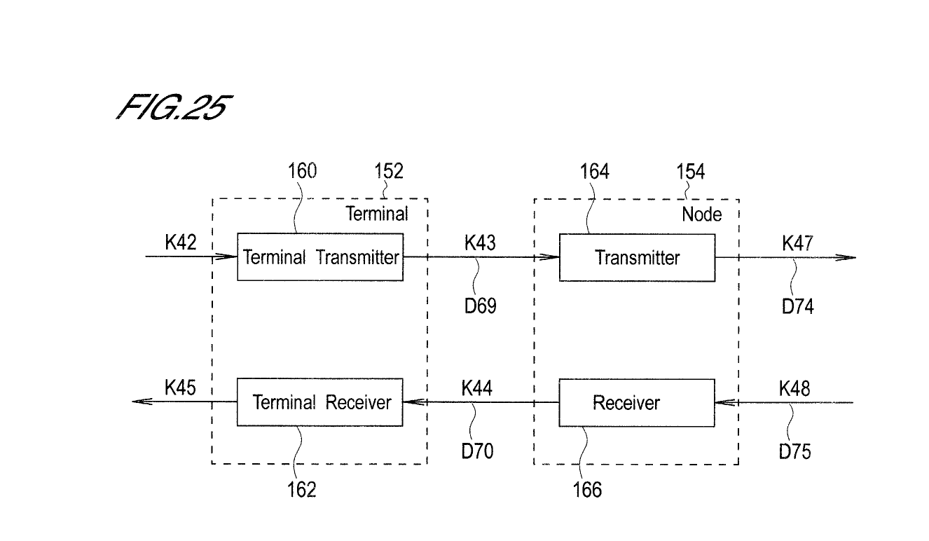

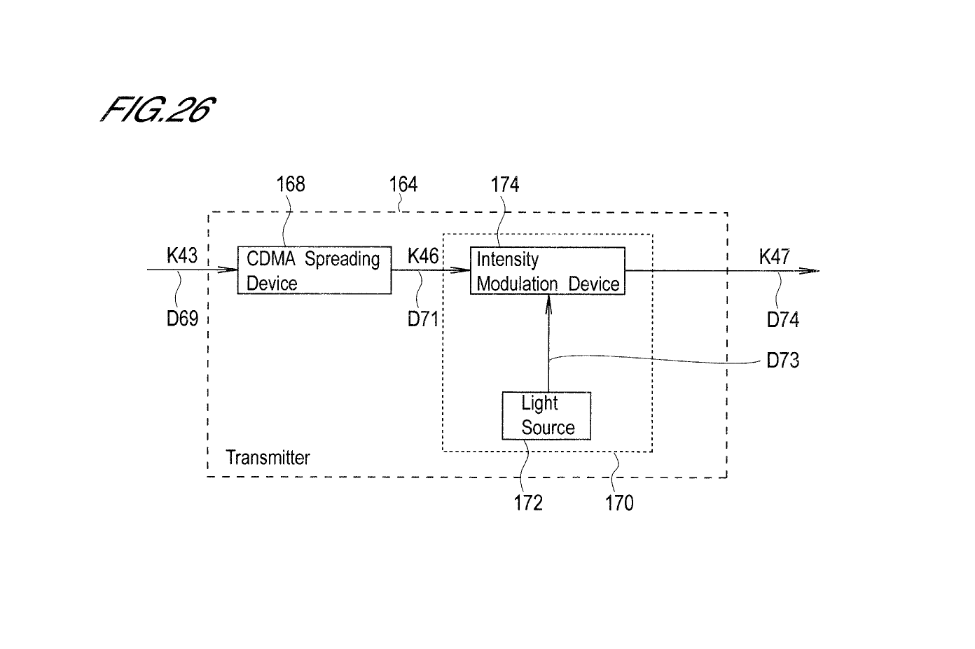

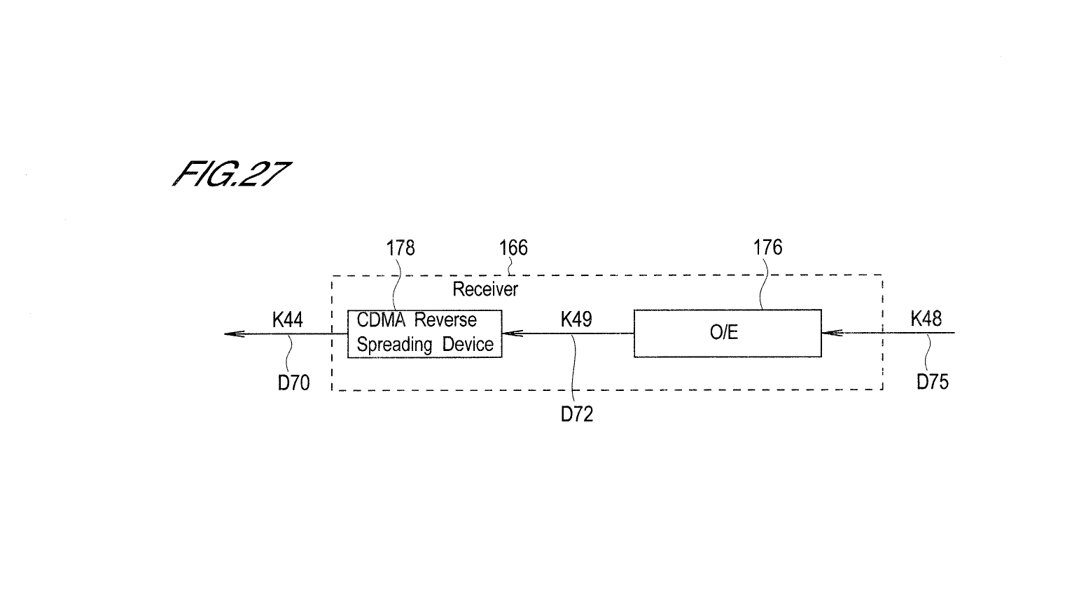

Next, the internal configurations of the terminals 152 and nodes 154 diagrammed in FIG. 24 are described with reference to FIGS. 25, 26, and 27. FIG. 25 is a block diagram of the internal configuration of a terminal and a node. FIG. 26 is a block diagram of the configuration of a transmitter. And FIG. 27 is a block diagram of the configuration of a receiver.

As diagrammed in FIG. 25, the terminal 152 is configured by a terminal transmitter 160 and a terminal receiver 162. The node 154 is configured by a transmitter 164 and a receiver 166.

As diagrammed in FIG. 26, moreover, the transmitter 164 is configured with a CDMA spreading device 168 and an electric-to-optical conversion device (hereinafter called E/O) 170. This E/O 170 is configured by a light source 172 and an intensity modulation device 174.

As diagrammed in FIG. 27, the receiver 166 is configured with an optical-to-electric conversion device (hereinafter called O/E) 176 and a CDMA reverse spreading device 178.

Next, the connection relationships between the components configuring the terminals 152 and the nodes 154 are described. In the network system 150, 69th to 75th transmission paths D69 to D75 are provided as connection circuit lines.

The 69th transmission path D69 connects between the terminal transmitter 160 and the CDMA spreading device 168. The 70th transmission path D70 connects between the terminal receiver 162 and the CDMA reverse spreading device 178.

These transmission paths D69 and D70 configure the electrical circuit line Q1 indicated in FIG. 24.

The 71st transmission path D71 connects between the CDMA spreading device 168 and the intensity modulation device 174. The 72nd transmission path D72 connects between the CDMA reverse spreading device 178 and the O/E 176. And the 73rd transmission path D73 connects between the light source 172 and the intensity modulation device 174.

The 74th transmission path D74 connects between the intensity modulation device 174 and the star coupler 156 indicated in FIG. 24. And the 75th transmission path D75 connects between the O/E 176 and the star coupler 156 indicated in FIG. 24.

These transmission paths D74 and D75 configure the optical transmission path Q2 indicated in FIG. 24.

Next, the functions of the components configuring the terminal 152 are described.

To the terminal transmitter 160 are input raw data K42 (such as audio or image data, etc.) output from a transmitting party (the user of the terminal 152). The terminal transmitter 152 converts the input raw data K42 to data K43 that are an electrical signal. After that has been done, the terminal transmitter 160 sends the converted data K43 to the 69th transmission path D69. These data K43 are sent via that 69th transmission path D69 to the CDMA spreading device 168 of the transmitter 164.

To the terminal transmitter 162 are input the data K44 sent from the CDMA reverse spreading device 178 of the receiver 166, via the 70th transmission path D70. These data K44 are an electrical signal. The terminal receiver 162, upon receiving the data K44, converts those data K44 to the format (audio or image, etc.) of the original raw data K45. After that is done, the terminal receiver 162 outputs the converted raw data K45 to the terminal 152.

Next, the functions of the components configuring the transmitter 164 of the node 154 are described.

The CDMA spreading device 168 spreads the data K43 received from the terminal 152 with a prescribed code, converting those data to first data K46.

To this CDMA spreading device 168 are input, via the 69th transmission path D69, the data K43 sent from the terminal transmitter 160. The CDMA spreading device 168 spreads the input data K43 with a prescribed code. That is, the CDMA spreading device 168 performs code division multiple access. In other words, in the CDMA spreading device 168, input data are subjected to spectrum spreading. As a result of this spreading, the data K43 are converted to the first data K46. These first data K46 are an electrical signal.

The CDMA spreading device 168 then sends the first data K46 to the 71st transmission path D71. These first data K46 are sent via that 71st transmission path D71 to the intensity modulation device 174 of the E/O 170.

The E/O 170 converts the first data K46 sent from the CDMA spreading device 168 to second data K47 which are an optical signal, and transmits these second data K47 to the optical communications network 158.

As described earlier, moreover, the E/O 170 comprises a light source 172 which outputs light and an intensity modulation device 174. This intensity modulation device 174 is a device that modulates the intensity of the light output from the light source 172 according to the received first data K46, and transmits that modulated light as the second data K47.

At the E/O 170, the light generated by the light source 172 is continuously output to the 73rd transmission path D73. This light is sent via that 73rd transmission path D73 to the intensity modulation device 174. The intensity modulation device 174 modulates the intensity of the light output from the light source 172 according to the received first data K46. The intensity modulation device 174 then transmits the modulated light as the second data K47 to the 74th transmission path D74. These second data K47 are sent via that 74th transmission path D74 to the star coupler 156 indicated in FIG. 24.

Next, the functions of the components configuring the receiver 166 of the node 154 are described.

The O/E 176 is a device that converts second data K48 received from the optical communications network 158 to first data K49 that are an electrical signal.

The second data K48 output from the star coupler 156 indicated in FIG. 24 are input to the O/E 176 via the 75th transmission path D75. The O/E 176 converts the input second data K47 to first data K49 that are an electrical signal. The O/E 176 then sends the first data K49 to the 72nd transmission path D72. These first data K49 are sent via that 72nd transmission path D72 to the CDMA reverse spreading device 178.

The CDMA reverse spreading device 178 is a device that subjects the first data K49 sent from the O/E 176 to reverse spreading with a prescribed code, converting those data to data K44, and transmitting those data K44 to the terminal 152.

To the CDMA reverse spreading device 178 described earlier, the first data K49 output from the O/E 176 are input, via the 72nd transmission path D72. The CDMA reverse spreading device 178 subjects the first data K49 input via the 72nd transmission path D72 to reverse spreading with a prescribed code. That is, in the CDMA reverse spreading device 178, input data are subjected to spectrum reverse spreading. As a result of this reverse spreading, the first data K49 are converted to data K44. These data K44 are an electrical signal. Thus the CDMA reverse spreading device 178 receives only the first data K49 of the prescribed code.

The data K44 obtained by the CDMA reverse spreading device 178 are sent to the 70th transmission path D70. These data K44 are sent via that 70th transmission path D70 to the terminal receiver 162.

As described in the foregoing, it is possible to implement a code division multiple access type network system. According to this configuration, data reproduction quality is good because code division multiple access is performed. Also, data transfers between nodes are conducted with optical signals, wherefore communications are made high-speed.

What is claimed is:

1. A network system comprising:
n terminals and n nodes (where n is an integer 2 or greater); wherein:
each said terminal is connected individually to each said node;
said nodes are mutually connected, configuring a communications network;
a connection establishing channel, and data transmission channels that are assigned to each of said nodes, are established in said communications network;
each said node uses said connection establishing channel to continuously circulate a token within said communications network;
said nodes, upon acquiring said tokens, are capable of requesting establishment of connections between other said nodes, using said connection establishing channel; and
said nodes, after establishing said connections, perform data transmission using said data transmission channels.

2. A network system according to claim 1, wherein: connections between said terminals and nodes are made electrically; mutual connections between said terminals are made optically; said communications network is an optical communications network; and said nodes perform conversions from optical signals to electrical signals or conversions from electrical signals to optical signals.

3. A network system according to claim 1, wherein each of said nodes, when a data transmission request is generated to said terminal connected to that node, upon acquiring said token, transmits connection information necessary for establishing said connection to said node at data transmission destination.

4. A network system according to claim 3, wherein said connection information is transmitted after being consolidated with said token in a token packet.

5. A network system according to claim 4, wherein:
said data transmission channels are made n channels assigned one by one, without redundancy, to each of said nodes;
said connection establishing channel is made (n+1)th channel;
said nodes each comprise a transmitter, a receiver, and a connection processor;
said transmitter comprises a first and a second data transmitter and a first and a second token transmitter;
said receiver comprises a first and a second data receiver and a first and a second token receiver;
said connection processor is connected to said terminal, said first token transmitter, said first data receiver, and said second token receiver;
said first data transmitter and said second data receiver are respectively connected to said terminal;
said first data receiver is connected to said second data receiver;
said first token receiver is connected to said second token receiver;
said second data transmitter is connected to said first data transmitter;
said second token transmitter is connected to said first token transmitter;
said first data transmitter is a device that converts data received from said terminal to first data in a prescribed format, and transmits the first data to said second data transmitter;
said second data transmitter is a device that converts said first data received from said first data transmitter to second data on one of said data transmission channels and transmits those second data to said communications network;
said first token transmitter is a device that produces said token packet and transmits the token packet to said second token transmitter;
said second token transmitter is a device that converts said token packet received from said first token transmitter to a first token packet on said (n+1)th channel and transmits the first token packet to said communications network;
said first data receiver is a device that selects one of said data transmission channels and thereby receives said second data from said communications network, converts the second data to said first data, and transmits the first data to said second data receiver;
said second data receiver is a device that converts said first data received from said first data receiver to said data and transmits the data to said terminal;
said first token receiver is a device that receives said first token packet from said communications network using said (n+1)th channel, converts the first token packet to said token packet, and transmits the token packet to said second token receiver;
said second token receiver is a device that extracts said token and said connection information relating to the second token receiver from said token packet received from said first token receiver, and transmits the token and the connection information to said connection processor; and
said connection processor is a device that, upon receiving a data transmission request from said terminal connected to the connection processor, performs processing for causing said first token transmitter to produce said connection information as prescribed, and, upon receiving said token and said connection information from said second token receiver, if establishment of said connection is possible, performs processing for causing said first data receiver connected to the connection processor to select said data transmission channel assigned to said node originating data transmission.

6. A network system according to claim 5, wherein:
connections between said terminals and said nodes are made electrically;
mutual connections between said nodes are made optically;
said communications network is an optical communications network;
said data, said first data, and said token packets are electrical signals; and
said second data and said first token packets are optical signals.

7. A network system according to claim 6, wherein:
said data transmission channels have light wavelengths from λ₁ to λₙ, respectively;
said (n+1)th channel has a light wavelength λₙ₊₁;
said second data transmitter is a first electric-to-optical conversion device for converting said first data received to said second data having one of the wavelengths from λ₁ to λₙ;
said first data receiver comprises a variable wavelength filter for receiving said second data from said communications network by selecting one of the wavelengths from λ₁ to λₙ, and a first optical-to-electric conversion device for converting said second data sent from the variable wavelength filter to said first data;
said second token transmitter is a second electric-to-optical conversion device for converting said token packet received to said first token packet of wavelength λₙ₊₁; and
said first token receiver comprises a fixed wavelength filter for receiving said first token packet of wavelength λₙ₊₁ from said communications network, and a second optical-to-electric conversion device for converting said first token packet sent from that fixed wavelength filter to said token packet.

8. A network system according to claim 6, wherein:
said data transmission channels are respectively designated by codes from C₁ to Cₙ in code division multiple access;
said (n+1)th channel is designated by code Cₙ₊₁ in code division multiple access;
said second data transmitter comprises a first CDMA spreading device for spreading said first data received with one of the codes from C₁ to Cₙ to convert the data to third data, and a first electric-to-optical conversion device for converting said third data sent from that first CDMA spreading device to said second data;
said first data receiver comprises a first optical-to-electric conversion device for converting said second data received to said third data, and a first CDMA reverse spreading device for reverse-spreading said third data sent from the first optical-to-electric conversion device with one of the codes from C₁ to Cₙ to convert the data to said first data;
said second token transmitter comprises a second CDMA spreading device for spreading said token packet received with code Cₙ₊₁ to convert the token packet to a second token packet, and a second electric-to-optical conversion device for converting said second token packet sent from the second CDMA spreading device to said first token packet; and
said first token receiver comprises a second optical-to-electric conversion device for converting said first token packet received to said second token packet, and a second CDMA reverse spreading device for reverse-spreading said second token packet sent from the second optical-to-electric conversion device with code Cₙ₊₁ to convert the second token packet to said token packet.

9. A network system according to claim 8, wherein said third data transmitted from said first CDMA spreading device and said second token packet transmitted from said second CDMA spreading device are led through an electrical converging device to one transmission path; and
transmission path is connected to an electric-to-optical conversion device that functions both as said first electric-to-optical conversion device and as said second electric-to-optical conversion device.

10. A network system according to claim 8, wherein:
said second data and first token packet sent from said communications network are input to an optical-to-electric conversion device that functions both as said first optical-to-electric conversion device and as said second optical-to-electric conversion device; and
one transmission path connected to said optical-to-electric conversion device is coupled to said first and second CDMA reverse spreading devices through an electrical branching device.

11. A network system according to claim 8, wherein each of said first and second electric-to-optical conversion devices comprises a light source for outputting light, and an intensity modulation device for modulating intensity of light output from said light source according to said second token packet or third data received, and transmitting the modulated light as said first token packet or second data.

12. A network system according to claim 6, wherein:
when n=n(p, q)=p×q (where p and q are natural numbers); said data transmission channels are combinations of a light wavelength λᵢ (where i is a natural number from 1 to p) and a code Cⱼ (where j is a natural number from 1 to q) in code division multiple access; and said (n+1)th channel has light wavelength λₚ₊₁;
said second data transmitter comprises a CDMA spreading device for spreading said first data received, with one of the codes from C₁ to C_{q} to convert the data to third data, and a first electric-to-optical conversion device for converting said third data sent from the CDMA spreading device to said second data having one of the wavelengths from λ₁ to λₚ;
said first data receiver comprises a variable wavelength filter for receiving said second data from said communications network by selecting one of the wavelengths from λ₁ to λₚ, a first optical-to-electric conversion device for converting said second data sent from that variable wavelength filter to said third data, and a CDMA reverse spreading device for reverse-spreading said third data sent from that first optical-to-electric conversion device, with one of the codes from C₁ to C_{q}, to convert the data to said first data;
said second token transmitter is a second electric-to-optical conversion device that converts said token packet received to said first token packet of wavelength λₚ₊₁; and
said first token receiver comprises a fixed wavelength filter for receiving said first token packet of wavelength λₚ₊₁ from said communications network, and a second optical-to-electric conversion device for converting said first token packet sent from that fixed wavelength filter to said token packet.

13. A network system according to claim 12, wherein said first electric-to-optical conversion device comprises a light source for outputting light, a filter that transmits light output from the light source having one of the wavelengths from λ₁ to λₚ, and an intensity modulation device that modulates intensity of light output from the filter according to said third data received, and transmits the modulated light as said second data.

14. A network system according to claim 12, wherein said second electric-to-optical conversion device comprises a light source for outputting light, a filter that transmits light output from the light source having wavelength of λₚ₊₁, and an intensity modulation device that modulates intensity of light output from the filter according to said token packet received, and transmits the modulated light as said first token packet.

15. A network system comprising:
n terminals and n nodes (where n is an integer 2 or greater); wherein:
said terminals are each connected electrically and individually to each of said nodes;
said nodes are mutually connected optically, configuring an optical communications network;
said nodes each comprise a transmitter and a receiver;
said transmitter and said receiver are respectively connected to one of said terminals;
said transmitter comprises a CDMA spreading device for spreading data received from said terminal, with a prescribed code, to convert those data to first data, and an electric-to-optical conversion device for converting said first data sent from the CDMA spreading device to second data that are an optical signal, and transmitting the second data to said optical communications network; and
said receiver comprises an optical-to-electric conversion device for converting said second data received from said optical communications network to said first data that are an electrical signal, and a CDMA reverse spreading device for reverse-spreading said first data sent from the optical-to-electric conversion device, with a prescribed code, to convert [those first data] to said data, and transmitting those data to said terminal.

16. A network system according to claim 15, wherein said electric-to-optical conversion device comprises a light source for outputting light, and an intensity modulation device for modulating intensity of light output from the light source, according to said first data received, and transmitting the modulated light as said second data.
